(19) United States
(12) Patent Application Publication
(10) Pub. No.: US 2026/0023256 A1
(43) Pub. Date: Jan. 22, 2026

(54) Visual Optical Lens Assembly and VR Eyepiece System

(71) Applicant: ZHEJIANG SUNNY OPTICS CO., LTD., Ningbo (CN)

(72) Inventors: Huan LIU, Ningbo (CN); Xiaobin ZHANG, Ningbo (CN); Lin HUANG, Ningbo (CN); Yinfang JIN, Ningbo (CN); Liefeng ZHAO, Ningbo (CN)

(21) Appl. No.: 18/972,654

(22) Filed: Dec. 6, 2024

(30) Foreign Application Priority Data
Jul. 22, 2024 (CN) 202410990571.8

(51) Int. Cl. G02B 25/00; G02B 5/30; G02B 17/08; G02B 27/00; G06F 1/16

(52) U.S. Cl. CPC G02B 25/001; G02B 5/3025; G02B 17/0808; G02B 27/0081; G06F 1/163

(57) ABSTRACT

The disclosure provides a visual optical lens assembly and a Virtual Reality (VR) eyepiece system. The visual optical lens assembly sequentially includes, along an optical axis from an object side to an image side: a first lens having a refractive power, a reflective polarizing element, a second lens having a negative refractive power, a quarter-wave plate, a third lens having a negative refractive power, and a partially-reflective element. An image-side surface of the first lens is a convex surface; object-side surfaces and image-side surfaces of the second and third lenses respectively are concave surfaces and convex surfaces; the first lens to the third lens are sequentially glued, and the visual optical lens assembly meets a relational expression:

$$1 < TTL / ( ImgH \times tan ( Semi - FOV ) ) < 2.3 ; and 0.9 < \sum CT / TD < 1 .$$

### CROSS-REFERENCE TO RELATED APPLICATION(S)

This application claims priority to Chinese Patent Application No. 202410990571.8 filed on Jul. 22, 2024, the entire contents of each of which are incorporated herein by reference for all purposes. No new matter has been introduced.

### FIELD

The disclosure relates to the technical field of light path folding, and in particular, to a visual optical lens assembly and a Virtual Reality (VR) eyepiece system.

### BACKGROUND

In recent years, based on the concept of meta-universe, an Augmented Reality (AR)/Virtual Reality (VR) technology is ushering in unprecedented development opportunities. As the AR/VR technology continues to advance and innovate, the demand for immersive experiences will continue to increase, so as to promote the popularization and expanding application range of AR/VR devices. In particular, in the fields such as education, entertainment, work, healthcare, etc., the AR/VR technology will play an increasingly important role, bringing new experiences and convenience to users.

As an important entry point for human-computer interaction, the quality and design of a VR imaging lens become crucial, especially with the emerging of a Pancake (light path folding) solution, the light path folding technology successfully compresses a body length of a lens, and improves the comfort and experience of a head-mounted device, thereby bringing a better VR experience to consumers. However, an existing light path folding solution generally uses a system with two lenses, that is, a light path folding assembly is disposed in single lens assemblies arranged at intervals, causing a length of the entire lens to be relatively long and inconvenient to carry and wear, and also leading to poor imaging quality caused by significant loss of light energy due to reflection and scattering on a surface of the lens.

### SUMMARY

Some embodiments of the disclosure are to provide a visual optical lens assembly and a VR eyepiece system, which can decrease volumes and weights, improve portability and practicality, and simultaneously bring clearer and more realistic VR experience to users, thereby improving user immersion and participation degrees.

In order to implement the above advantage of the disclosure or other advantages and objectives, the disclosure provides a visual optical lens assembly, sequentially including, along an optical axis from an object side to an image side: a first lens having a refractive power, a reflective polarizing element, a second lens having a negative refractive power, a quarter-wave plate, a third lens having a negative refractive power, and a partially-reflective element. An image-side surface of the first lens is a convex surface; an object-side surface of the second lens is a concave surface, and an image-side surface of the second lens is a convex surface; an object-side surface of the third lens is a concave surface, and an image-side surface of the third lens is a convex surface; and the first lens, the second lens, and the third lens are sequentially glued, and the visual optical lens assembly meets a relational expression.

$$1. 3 < TTL / ( ImgH \times tan ( Semi - FOV ) ) < 2.2 ; and 0.9 < \sum CT / TD < 1.$$

the TTL is an on-axis distance between an object-side surface of the first lens and an imaging surface of the visual optical lens assembly; ImgH is half a diagonal length of an effective pixel region on the imaging surface of the visual optical lens assembly; the Semi-FOV is half a maximum Field Of View (FOV) of the visual optical lens assembly; the ΣCT is a sum of center thicknesses of the first lens, the second lens, and the third lens on the optical axis; and the TD is an on-axis distance between the object-side surface of the first lens and the image-side surface of the third lens.

Through such arrangement, a total length of an optical system is limited within a certain range, such that volume and weight may be decreased, and portability and practicality are improved. The size of a screen of an image source may be restrained by controlling the image height ImgH, so as to clarify a selection direction of the screen. Therefore, for the visual optical lens assembly of the disclosure, by controlling a relationship among the total length TTL, image height ImgH, and FOV of the optical system to be 1<TTL/(ImgH×tan (Semi-FOV))<2.3, the total length TTL of the optical system is small, and the FOV is large, such that the “thin” feature of the optical system is met, and the feature of a large field of view of the optical system is also met, so as to bring clearer and more realistic VR experience to users, thereby improving user immersion and participation degrees. Meanwhile, in the visual optical lens assembly of the disclosure, the range of a ratio of the sum of the center thicknesses of the first lens, the second lens, and the third lens on the optical axis to the on-axis distance between the object-side surface of the first lens and the image-side surface of the third lens is also limited to be 0.9<ΣCT/TD<1, so as to control a ratio of a thickness of a film layer with glue to the sum of the thicknesses of the lenses. On the one hand, difficulty in film attachment caused by too thin film layers may be avoided, and unfirm gluing due to too thin glue layers can also be avoided, and on the other hand, the problem of excessive glue due to too thick glue layers can also be prevented.

In one embodiment of the disclosure, the visual optical lens assembly further meets a relational expression.

$$0.1 < BFL / f < 0.4 .$$

The BFL is an on-axis distance between the image-side surface of the third lens and the imaging surface of the visual optical lens assembly; and the f is an effective focal length of the visual optical lens assembly.

Through such arrangement, in the visual optical lens assembly of the disclosure, by controlling a ratio of the BFL and the effective focal length f, distortion and aberration may be reduced, and resolution and color expressiveness of an image are improved. Meanwhile, the size, weight, and performance of the system may be better balanced by controlling the ratio BFL/f between 0.1 and 0.5, such that the impact of too small BFL on protective glass in front of a light source or a placement space of a black structure may be avoided, and an increase in the size and weight of the system due to the too large BFL can also be avoided.

In one embodiment of the disclosure, the visual optical lens assembly further meets a relational expression.

$$0.1 < EPD / ImgH < 0.4 .$$

The EPD is an Entrance Pupil Diameter (EPD) of the visual optical lens assembly; and the ImgH is half the diagonal length of the effective pixel region on the imaging surface of the visual optical lens assembly.

Through such arrangement, in the visual optical lens assembly of the disclosure, by controlling the ratio of the EPD to the image height ImgH to be between 0.1 and 0.4, the size of the screen may be restrained with a certain eye pupil size, facilitating the clarification of the selection direction of the screen.

In one embodiment of the disclosure, the first lens and the second lens meet a relational expression.

$$- 1.1 < ( f 1 * N 1 ) / ( f 2 * N 2 ) < 0.9 .$$

The f1 is an effective focal length of the first lens; the f2 is an effective focal length of the second lens; the N1 is a refractive index of the first lens; and the N2 is a refractive index of the second lens.

Through such arrangement, in the visual optical lens assembly of the disclosure, by limiting the focal length and refractive index of the first lens and the second lens, a magnification ratio of the optical system may be controlled. Meanwhile, by rationally selecting the refractive indexes of the lenses, the aberration of the optical system may be effectively controlled to improve imaging quality.

In one embodiment of the disclosure, the first lens, the second lens, and the third lens meet a relational expression.

$$0.5 < \sum ET / \sum CT < 0.7 .$$

The ΣET is a sum of edge thicknesses of the first lens, the second lens, and the third lens; and the ΣCT is the sum of center thicknesses of the first lens, the second lens, and the third lens on the optical axis.

Through such arrangement, in the visual optical lens assembly of the disclosure, by controlling the ratio of the sum of the edge thicknesses of all lenses to the sum of the center thicknesses, the shapes of the lenses are controlled, so as to reduce difficulties in lens imaging, processing, and gluing.

In one embodiment of the disclosure, the third lens meets a relational expression.

$$- 1.4 < f 3 / f < - 0.6 .$$

The f3 is an effective focal length of the third lens; and the f is an effective focal length of the visual optical lens assembly.

Through such arrangement, in the visual optical lens assembly of the disclosure, by controlling the ratio of the effective focal length f3 of the third lens to a focal length f of the system, the refractive power of the system is rationally allocated, facilitating system imaging, thereby improving the performance of the optical system.

In one embodiment of the disclosure, the second lens and the third lens meet a relational expression.

$$0.6 < ( CT 2 * N 2 + CT 3 * N 3 ) / TTL < 1.1 .$$

The CT2 is the center thickness of the second lens; the N2 is a refractive index of the second lens; the CT3 is the center thickness of the third lens; the N3 is a refractive index of the third lens; and the TTL is the on-axis distance between the object-side surface of the first lens and the imaging surface of the visual optical lens assembly.

Through such arrangement, in the visual optical lens assembly of the disclosure, by controlling a ratio of an optical path passing through the second lens and the third lens to the total length TTL of the optical system, the overall size and weight of the system are better controlled, thereby meeting requirements for portable wearing.

In one embodiment of the disclosure, a curvature radius of the image-side surface of the first lens is equal to a curvature radius of the object-side surface of the second lens; and a curvature radius of the image-side surface of the second lens is equal to a curvature radius of the object-side surface of the third lens.

Through such arrangement, the gluing of the lenses is achieved, so as to form glue layers with uniform and consistent thicknesses between the adjacent lenses.

In one embodiment of the disclosure, the reflective polarizing element is a reflective polarizing film attached to the object-side surface of the second lens; and the quarter-wave plate is attached to the object-side surface of the third lens.

Through such arrangement, in the visual optical lens assembly of the disclosure, the reflective polarizing film reflects light in one polarization direction and transmits light orthogonal to the polarization direction, the quarter-wave plate changes the polarization direction of the light, and the partially-reflective element implements reflection and transmission of the light, such that the returning of a light path of the system is realized by combining the second lens and the third lens, facilitating the shortening of the length of the lens, thereby realizing an ultra-thin design of the optical system.

In one embodiment of the disclosure, a center thickness of the reflective polarizing element is equal to a center thickness of the quarter-wave plate.

Through such arrangement, in the visual optical lens assembly of the disclosure, by controlling the center thickness of the reflective polarizing element to be equal to the center thickness of the quarter-wave plate, difficulty in film attachment caused by too thin film layers may be avoided, and an increase in the total optical length and material waste due to too thick film layers can also be avoided.

In one embodiment of the disclosure, a refractive index of the reflective polarizing element is equal to a refractive index of the quarter-wave plate; and an abbe number of the reflective polarizing element is equal to an abbe number of the quarter-wave plate.

Through such arrangement, in the visual optical lens assembly of the disclosure, by controlling material attributes (including the refractive index and the abbe number) of the reflective polarizing element and the quarter-wave plate, a large difference in the material attributes among the lenses may be avoided, thereby preventing the occurrence of total reflection of light or other aberrations.

In one embodiment of the disclosure, the second lens and the reflective polarizing element meet a relational expression.

$$1 < N 2 / NRP < 1.2 .$$

The N2 is the refractive index of the second lens; and the NRP is a refractive index of the reflective polarizing element.

Through such arrangement, in the visual optical lens assembly of the disclosure, by controlling a refractive index ratio of the second lens to the reflective polarizing element to be between 1 and 1.2, a large difference in the material attributes between the second lens and the reflective polarizing element may be avoided, thereby preventing the occurrence of total reflection of light or other aberrations.

In one embodiment of the disclosure, the third lens and the quarter-wave plate meet a relational expression.

$$1 < N 3 / NQWP < 1.2 .$$

The N3 is the refractive index of the third lens, and the NQWP is a refractive index of the quarter-wave plate.

Through such arrangement, in the visual optical lens assembly of the disclosure, by controlling a refractive index ratio of the third lens to the quarter-wave plate to be between 1 and 1.2, a large difference in the material attributes between the third lens and the quarter-wave plate may be avoided, thereby preventing total reflection of light or other aberrations.

In one embodiment of the disclosure, the partially-reflective element is a semi-reflective and semi-permeable film glued with the image-side surface of the third lens.

Through such arrangement, when light emitted by the screen passes through the image-side surface of the third lens for the first time, only part of the light transmitted is required, and when the light is reflected back to the image-side surface of the third lens by the reflective polarizing element, only the part of the light reflected is required, so as to realize light returning. Meanwhile, the part of the light abandoned returns back to the screen side, and does not enter human eyes to form stray light and ghost Images.

In one embodiment of the disclosure, the visual optical lens assembly further includes glue coating layers located among the first lens, the second lens, and the third lens.

Through such arrangement, in the visual optical lens assembly of the disclosure, all the lenses may be glued through the glue coating layers, such that the glue layer has a certain thickness, facilitating improvement of the stability of gluing the lenses. Meanwhile, the refractive index of the glue coating layer is closer to the refractive index of the lens compared to air, such that the total reflection of light or other aberrations caused by air gaps and the large difference in the material attributes of lens members may be avoided.

An embodiment of the disclosure further provides a VR eyepiece system, including: above the visual optical lens assemblies described above and a screen.

The screen is disposed on an image side of the visual optical lens assembly, and a light source surface of the screen is located on an imaging surface of the visual optical lens assembly.

### BRIEF DESCRIPTION OF DRAWINGS

FIG. 1 is a schematic structural diagram of a VR eyepiece system according to an embodiment of the disclosure.

FIG. 2 is a schematic diagram of a light path principle of the VR eyepiece system according to the above embodiment of the disclosure.

FIG. 3 shows Example I of a visual optical lens assembly in the VR eyepiece system according to the above embodiment of the disclosure.

FIG. 4A is a schematic longitudinal aberration diagram of the visual optical lens assembly according to the above Example I of the disclosure.

FIG. 4B is a schematic astigmatism diagram of the visual optical lens assembly according to the above Example I of the disclosure.

FIG. 4C is a schematic distortion diagram of the visual optical lens assembly according to the above Example I of the disclosure.

FIG. 5 shows Example II of the visual optical lens assembly in the VR eyepiece system according to the above embodiment of the disclosure.

FIG. 6A is a schematic longitudinal aberration diagram of the visual optical lens assembly according to the above Example II of the disclosure.

FIG. 6B is a schematic astigmatism diagram of the visual optical lens assembly according to the above Example II of the disclosure.

FIG. 6C is a schematic distortion diagram of the visual optical lens assembly according to the above Example II of the disclosure.

FIG. 7 shows Example III of the visual optical lens assembly in the VR eyepiece system according to the above embodiment of the disclosure.

FIG. 8A is a schematic longitudinal aberration diagram of the visual optical lens assembly according to the above Example III of the disclosure.

FIG. 8B is a schematic astigmatism diagram of the visual optical lens assembly according to the above Example III of the disclosure.

FIG. 8C is a schematic distortion diagram of the visual optical lens assembly according to the above Example III of the disclosure.

FIG. 9 shows Example IV of the visual optical lens assembly in the VR eyepiece system according to the above embodiment of the disclosure.

FIG. 10A is a schematic longitudinal aberration diagram of the visual optical lens assembly according to the above Example IV of the disclosure.

FIG. 10B is a schematic astigmatism diagram of the visual optical lens assembly according to the above Example IV of the disclosure.

FIG. 10C is a schematic distortion diagram of the visual optical lens assembly according to the above Example IV of the disclosure.

FIG. 11 shows Example V of the visual optical lens assembly in the VR eyepiece system according to the above embodiment of the disclosure.

FIG. 12A is a schematic longitudinal aberration diagram of the visual optical lens assembly according to the above Example V of the disclosure.

FIG. 12B is a schematic astigmatism diagram of the visual optical lens assembly according to the above Example V of the disclosure.

FIG. 12C is a schematic distortion diagram of the visual optical lens assembly according to the above Example V of the disclosure.

FIG. 13 shows Example VI of the visual optical lens assembly in the VR eyepiece system according to the above embodiment of the disclosure.

FIG. 14A is a schematic longitudinal aberration diagram of the visual optical lens assembly according to the above Example VI of the disclosure.

FIG. 14B is a schematic astigmatism diagram of the visual optical lens assembly according to the above Example VI of the disclosure.

FIG. 14C is a schematic distortion diagram of the visual optical lens assembly according to the above Example VI of the disclosure.

FIG. 15 shows Example VII of the visual optical lens assembly in the VR eyepiece system according to the above embodiment of the disclosure.

FIG. 16A is a schematic longitudinal aberration diagram of the visual optical lens assembly according to the above Example VII of the disclosure.

FIG. 16B is a schematic astigmatism diagram of the visual optical lens assembly according to the above Example VII of the disclosure.

FIG. 16C is a schematic distortion diagram of the visual optical lens assembly according to the above Example VII of the disclosure.

FIG. 17 shows Example VIII of the visual optical lens assembly in the VR eyepiece system according to the above embodiment of the disclosure.

FIG. 18A is a schematic longitudinal aberration diagram of the visual optical lens assembly according to the above Example VIII of the disclosure.

FIG. 18B is a schematic astigmatism diagram of the visual optical lens assembly according to the above Example VIII of the disclosure.

FIG. 18C is a schematic distortion diagram of the visual optical lens assembly according to the above Example VIII of the disclosure.

Description of main reference signs: 10, Visual optical lens assembly; 11, First lens; 12, Reflective polarizing element; 13, Second lens; 14, Quarter-wave plate; 15, Third lens; 16, Partially-reflective element; 17, Glue coating layer; 18, Protection element; 20, Screen; and 200, Light source surface.

The above description of the main component symbols in conjunction with the drawings and specific implementations provides a further detailed description of the disclosure.

### DESCRIPTION OF EMBODIMENTS

The following description is used to disclose the disclosure in order to enable those skilled in the art to realize the disclosure. The preferred embodiments in the following description are only for examples, and other obvious variants may be thought of by those skilled in the art. The basic principles of the disclosure defined in the following description may be applied to other implementation solutions, variation solutions, improvement solutions, equivalent solutions, and other technical solutions that do not depart from the spirit and scope of the disclosure.

In the description of the disclosure, it is to be understood that the terms “first”, “second”, etc. are used for descriptive purposes only and are not to be construed as indicative or suggestive of relative importance. In the description of the disclosure, it is to be noted that, unless otherwise clearly specified and limited, the terms “connected” and “connect” should be interpreted broadly. For example, the term “connect” may be fixed connection, detachable connection or integral construction. As an alternative, the term “connect” may be mechanical connection, or electrical connection. As an alternative, the term “connect” may be direct connection, or indirect connection by means of a medium. For those of ordinary skill in the art, specific meanings of the above terms in the disclosure may be understood according to a specific condition.

In the description of the specification, descriptions of the terms “an embodiment”, “some embodiments”, “example”, “specific example”, or “some examples”, mean that specific features, structures, materials, or characteristics described with reference to the implementations or examples are included in at least one implementation or example of the disclosure. In this specification, schematic representations of the above terms do not necessarily refer to the same embodiment or example. In addition, the described particular features, structures, materials or characteristics may be combined in any suitable manner in any one or more embodiments or examples. In addition, those skilled in the art may integrate and combine the different embodiments or examples described in this specification and the features of the different embodiments or examples without contradiction.

Considering that, for an existing system with two lenses, a light path folding assembly is disposed in single lens assemblies arranged at intervals, the entire lens has a relatively long length and inconvenient to carry and wear, and significant loss of light energy is caused due to reflection and scattering on a surface of the lens, resulting in poor imaging quality. Therefore, the disclosure creatively proposes a visual optical lens assembly and a VR eyepiece system, which can bring clearer and more realistic VR experience to users, thereby improving user immersion and participation degrees.

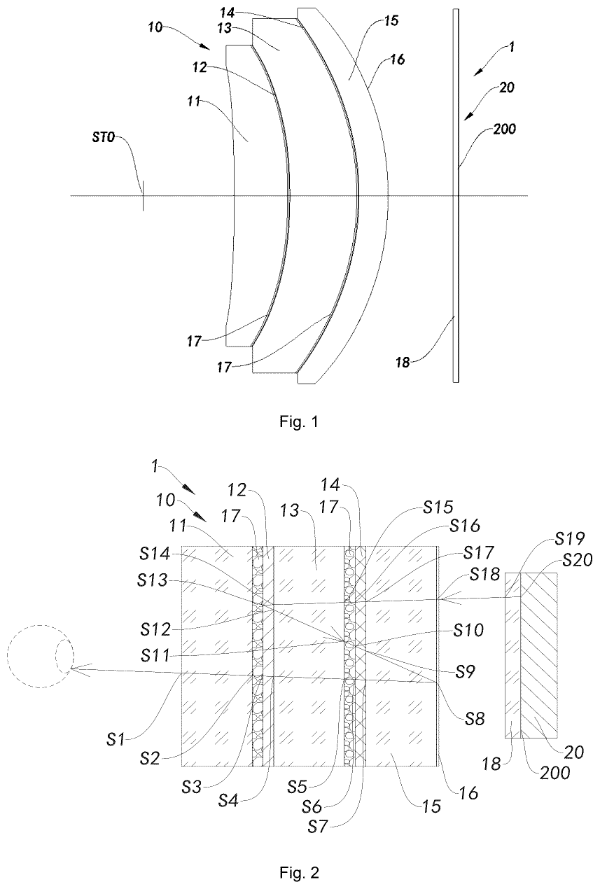

Referring to FIG. 1 and FIG. 2 of the drawings of the specification of the disclosure, an embodiment of the disclosure provides a VR eyepiece system, which may include a visual optical lens assembly 10 and a screen 20. The screen 20 is disposed on an image side of the visual optical lens assembly 10, and a light source surface 200 of the screen 20 is located on an imaging surface IMG of the visual optical lens assembly 10, such that image light emitted by the light source surface 200 of the screen 20 first transmits the visual optical lens assembly 10, and then enters human eyes to obtain VR experience. It may be understood that, the screen 20 mentioned in the disclosure may include, but is not limited to, a display device such as an LED display screen or an OLED display screen, and the disclosure is not described thereto again.

As shown in FIG. 1 to FIG. 18C, the visual optical lens assembly 10 may sequentially include, along an optical axis from an object side to an image side: a first lens 11 having a refractive power, a reflective polarizing element 12, a second lens 13 having a negative refractive power, a quarter-wave plate 14, a third lens 15 having a negative refractive power, and a partially-reflective element 16. An image-side surface of the first lens 11 is a convex surface; an object-side surface and an image-side surface of the second lens 13 respectively are a concave surface and a convex surface; and an object-side surface and image-side surface of the third lens 15 respectively are a concave surface and a convex surface.

The first lens 11, the second lens 13, and the third lens 15 are sequentially glued, and the visual optical lens assembly 10 meets a relational expression.

$$1.3 < TTL / ( ImgH \times tan ( Semi - F O V ) ) < 2.2 ; and$$

$$0.9 < \sum CT / TD < 1 .$$

TTL is an on-axis distance between an object-side surface of the first lens 11 and an imaging surface IMG of the visual optical lens assembly 10; ImgH is half a diagonal length of an effective pixel region on the imaging surface IMG of the visual optical lens assembly 10; Semi-FOV is half a maximum FOV of the visual optical lens assembly 10; CT is a sum of center thicknesses of the first lens 11, the second lens 13, and the third lens 15 on the optical axis; and TD is an on-axis distance between the object-side surface of the first lens 11 and the image-side surface of the third lens 15.

It is to be noted that, a total length TTL of an optical system is limited within a certain range, such that volume and weight may be decreased, and portability and practicality are improved. The size of a screen of an image source may be restrained by controlling the image height ImgH, so as to clarify a selection direction of the screen. Therefore, for the visual optical lens assembly 10 of the disclosure, by controlling a relationship among the total length TTL, image height ImgH, and Semi-FOV of the optical system to be 1.3<TTL/(ImgH×tan (Semi-FOV))<2.2, the total length TTL of the optical system is small, and the FOV is large, such that the “thin” feature of the optical system is met, and the feature of a large field of view of the optical system is also met, so as to bring clearer and more realistic VR experience to users, thereby improving user immersion and participation degrees. Meanwhile, in the visual optical lens assembly 10 of the disclosure, the range of a ratio of the sum of the center thicknesses of the first lens 11, the second lens 13, and the third lens 15 on the optical axis to the on-axis distance between the object-side surface of the first lens 11 and the image-side surface of the third lens 15 is also limited to be 0.9<ΣCT/TD<1, so as to control a ratio of a thickness of a film layer with glue to the sum of the thicknesses of the lenses. On the one hand, difficulty in film attachment caused by too thin film layers may be avoided, and unfirm gluing due to too thin glue layers can also be avoided, and on the other hand, the problem of excessive glue due to too thick glue layers can also be prevented.

In an embodiment, 1.32≤TTL/(ImgH×tan (Semi-FOV))≤2.15; and 0.96≤ΣCT/TD≤0.98.

It may be understood that, the reflective polarizing element 12 mentioned in the disclosure can reflect light in one polarization direction and transmits light orthogonal to the polarization direction; the quarter-wave plate 14 mentioned in the disclosure can change the polarization direction of the light, so as to cause the polarization direction of the light that passes through twice to rotate 900; and the partially-reflective element 16 mentioned in the disclosure can reflect and transmit the light according to a certain proportion, so as to cause one part of the light to be reflected, and the other part of the light to be transmitted. In this way, image light emitted by the light source surface 200 of the screen 20 first partially transmits the partially-reflective element 16, passes through the third lens 15, and then passes through the quarter-wave plate 14 for the first time so as to be converted into first polarized light (e.g., P light); then the light is reflected back to the second lens 13 by the reflective polarizing element 12 after passing through the second lens 13, so as to pass through the third lens 15 to be partially reflected back to the third lens 15 by the partially-reflective element 16 after passing through the quarter-wave plate 14 for the second time, and then the light passes through the quarter-wave plate 14 for the third time to be converted into second polarized light (e.g., S light); and then, the light enters human eyes for imaging after sequentially passing through the second lens 13, the reflective polarizing element 12, and the first lens 11, causing a user to obtain VR experience.

In addition, the object-side surface of the first lens 11 of the disclosure may be a concave surface, or may also be a convex surface. Accordingly, the refractive power of the first lens 11 may be negative, or may also be positive, which can both meet an imaging requirement for the visual optical lens assembly 10.

Exemplarily, the visual optical lens assembly 10 may further meet a relational expression.

$$0.1 < BFL / f < 0.4 .$$

BFL is an on-axis distance between the image-side surface of the third lens 15 and the imaging surface IMG of the visual optical lens assembly 10; and f is an effective focal length of the visual optical lens assembly 10.

In other words, the above relational expression stipulates the range of a ratio of the BFL and the effective focal length f, distortion and aberration may be reduced, and resolution and color expressiveness of an image are improved. Meanwhile, the size, weight, and performance of the system may be better balanced by controlling the ratio BFL/f between 0.1 and 0.4, such that the impact of too small BFL on protective glass in front of a light source or a placement space of a black structure may be avoided, and an increase in the size and weight of the system due to the too large BFL can also be avoided.

In an embodiment, 0.12≤BFL/f≤0.39.

In an embodiment, the visual optical lens assembly 10 further meets a relational expression.

$$0.1 < EPD / ImgH < 0.4 .$$

EPD is an Entrance Pupil Diameter of the visual optical lens assembly 10; and ImgH is half the diagonal length of the effective pixel region on the imaging surface IMG of the visual optical lens assembly 10.

In other words, the above relational expression stipulates the ratio of the EPD to the image height ImgH to be between 0.1 and 0.4, the size of the screen may be restrained with a certain eye pupil size, facilitating the clarification of the selection direction of the screen.

In an embodiment, 0.15≤EPD/ImgH≤0.34.

In an embodiment, the first lens 11 and the second lens 13 meet a relational expression.

$$- 1.1 < ( f 1 * N 1 ) / ( f 2 * N 2 ) < 0.9 .$$

f1 is an effective focal length of the first lens 11; f2 is an effective focal length of the second lens 13; N1 is a refractive index of the first lens 11; and N2 is a refractive index of the second lens 13.

In other words, the above relational expression stipulates a ratio of a product of the focal length and refractive index of the first lens to a product of the focal length and refractive index of the second lens to be between −1.1 and 0.9, such that a magnification ratio of the optical system may be controlled. Meanwhile, by rationally selecting the refractive indexes of the lenses, the aberration of the optical system may be effectively controlled to improve imaging quality.

In an embodiment, −1.05≤(f1*N1)/(f2*N2)≤0.82.

In an embodiment, the first lens 11, the second lens 13, and the third lens 15 meet a relational expression.

$$0.5 < \sum ET / \sum CT < 0.7 .$$

ΣCT is the sum of center thicknesses of the first lens 11, the second lens 13, and the third lens 15 on the optical axis; and ΣET is a sum of edge thicknesses of the first lens 11, the second lens 13, and the third lens 15.

In other words, the above relational expression stipulates a ratio of the sum (i.e., ΣET=ET1+ET2+ET3) of the edge thicknesses of the first lens 11, the second lens 13, and the third lens 15 to the sum (i.e., ΣCT=CT1+CT2+CT3) of the center thicknesses to be between 0.5 and 0.7, such that the shapes of the lenses are controlled, so as to reduce difficulties in lens imaging, processing, and gluing.

In an embodiment, 0.54≤ΣET/ΣCT≤0.62.

In an embodiment, the third lens 15 meets a relational expression.

$$- 1.4 < f 3 / f < - 0.6 .$$

f3 is an effective focal length of the third lens 15; and f is an effective focal length of the visual optical lens assembly 10.

In other words, the above relational expression stipulates a ratio of the effective focal length f3 of the third lens 15 to a focal length f of the system to be between −1.4 and −0.6, such that the refractive power of the system is rationally allocated, facilitating system imaging, thereby improving the performance of the optical system.

In an embodiment, −1.35≤f3/f≤−0.69.

In an embodiment, the second lens 13 and the third lens 15 meet a relational expression.

$$0.6 < ( CT 2 * N 2 + CT 3 * N 3 ) / TTL < 1.1$$

CT2 is the center thickness of the second lens 13; N2 is a refractive index of the second lens 13; CT3 is the center thickness of the third lens 15; N3 is a refractive index of the third lens 15; and TTL is the on-axis distance between the object-side surface of the first lens 11 and the imaging surface IMG of the visual optical lens assembly 10.

In other words, the above relational expression stipulates a ratio of a sum of optical paths passing through the second lens 13 and the third lens 15 to the total length TTL of the optical system to be between 0.6 and 1.1, so as to better control the overall size and weight of the system, thereby meeting requirements for portable wearing.

In an embodiment, 0.64≤(CT2*N2+CT3*N3)/TTL≤1.

In an embodiment, a curvature radius of the image-side surface of the first lens 11 is equal to a curvature radius of the object-side surface of the second lens 13; and a curvature radius of the image-side surface of the second lens is equal to a curvature radius of the object-side surface of the third lens.

In other words, in the visual optical lens assembly 10 of the disclosure, by controlling the curvature radius R2 of the image-side surface of the first lens 11 to be equal to the curvature radius R3 of the object-side surface of the second lens 13, and the curvature radius R4 of the image-side surface of the second lens 13 to be equal to the curvature radius R5 of the object-side surface of the third lens 15, that is to say, R2=R3 and R4=R5, the gluing of the lenses is achieved, so as to form glue layers with uniform and consistent thicknesses between the adjacent lenses.

In an embodiment, the reflective polarizing element 12 is implemented as a reflective polarizing film attached to the object-side surface of the second lens 13; and the quarter-wave plate 14 is attached to the object-side surface of the third lens 15. In this way, in the visual optical lens assembly 10 of the disclosure, the reflective polarizing film reflects light in one polarization direction and transmits light orthogonal to the polarization direction, the quarter-wave plate 14 changes the polarization direction of the light, and the partially-reflective element 16 implements reflection and transmission of the light, such that the returning of a light path of the system is realized by combining of the second lens 13 and the third lens 15, facilitating the shortening of the length of the lens, thereby realizing an ultra-thin design of the optical system.

In an embodiment, a center thickness of the reflective polarizing element 12 is equal to a center thickness of the quarter-wave plate 14.

In other words, in the visual optical lens assembly of the disclosure, by controlling the center thickness CTRP of the reflective polarizing element 12 to be equal to the center thickness CTQWP of the quarter-wave plate 14, that is, CTRP=CTQWP, difficulty in film attachment caused by too thin film layers may be avoided, and an increase in the total optical length and material waste due to too thick film layers can also be avoided.

In an embodiment, a refractive index of the reflective polarizing element 12 is equal to a refractive index of the quarter-wave plate 14; and an abbe number of the reflective polarizing element 12 is equal to an abbe number of the quarter-wave plate 14.

In other words, in the visual optical lens assembly of the disclosure, by controlling the refractive index NRP of the reflective polarizing element 12 to be equal to the refractive index NQWP of the quarter-wave plate 14, and the abbe number VRP of the reflective polarizing element 12 to be equal to the abbe number VQWP of the quarter-wave plate 14, that is, NRP=NQWP and VRP=VQWP, a large difference in the material attributes among the lenses may be avoided, thereby preventing the occurrence of total reflection of light or other aberrations.

In an embodiment, the second lens 13 and the reflective polarizing element 12 meet a relational expression.

$$1 < N 2 / NRP < 1.2 .$$

N2 is the refractive index of the second lens 13; and NRP is a refractive index of the reflective polarizing element 12.

In other words, the above relational expression stipulates a ratio of the refractive index N2 of the second lens 13 to the refractive index NRP of the reflective polarizing element 12 to be between 1 and 1.2, a large difference in the material attributes between the second lens 13 and the reflective polarizing element 12 may be avoided, thereby preventing the occurrence of total reflection of light at a junction of the second lens and the reflective polarizing element or other aberrations.

In an embodiment, 1.01≤N2/NRP≤1.13.

In an embodiment, the third lens 15 and the quarter-wave plate 14 meet a relational expression.

$$1 < N 3 / NQWP < 1.2 .$$

N3 is the refractive index of the third lens 15, and NQWP is a refractive index of the quarter-wave plate 14.

In other words, the above relational expression stipulates a ratio of the refractive index N3 of the third lens 15 to the refractive index NQWP of the quarter-wave plate 14 to be between 1 and 1.2, a large difference in the material attributes between the third lens 15 and the quarter-wave plate 14 may be avoided, thereby preventing total reflection of light or other aberrations.

In an embodiment, 1.01≤N3/NQWP≤1.11.

In an embodiment, the partially-reflective element 16 is implemented as a semi-reflective and semi-permeable film glued with the image-side surface of the third lens 15. In this way, when light emitted by the screen 20 passes through the image-side surface of the third lens 15 for the first time, only part of the light transmitted is required, and when the light is reflected back to the image-side surface of the third lens 15 by the reflective polarizing element 12, only the part of the light reflected is required, so as to realize light returning. Meanwhile, the part of the light abandoned returns back to the screen side, and does not enter human eyes to form stray light and ghost Images.

In an embodiment, the visual optical lens assembly 10 further includes glue coating layers 17 located among the first lens 11, the second lens 13, and the third lens 15, so as to fill gaps among the lenses. For example, as shown in FIG. 2, the glue coating layer 17 is disposed between the first lens 11 and the reflective polarizing element 12, and the glue coating layer 17 is disposed between the second lens 13 and the quarter-wave plate 14. In this way, in the visual optical lens assembly 10 of the disclosure, all the lenses may be glued through the glue coating layers 17, such that the glue layer has a certain thickness, facilitating improvement of the stability of gluing the lenses. Meanwhile, the refractive index of the glue coating layer 17 is closer to the refractive index of the lens compared to air, such that the total reflection of light or other aberrations caused by air gaps and the large difference in the material attributes of lens members may be avoided.

It is to be noted that, in some examples of the disclosure, the VR eyepiece system may further include a protection element 18 covering the light source surface 200. The protection element 18 may be, but is not limited to, implemented as protective glass or a optical filter, and the disclosure is not described thereto again. Furthermore, in the above embodiments of the disclosure, the protection element 18 may be directly attached to the light source surface 200 of the screen 20. Definitely, in other examples of the disclosure, the protection element 18 may also be glued to the source surface 200 of the screen 20, so as to form the glue coating layer 17 between the protection element and the source surface.

Some specific and non-limiting examples of embodiments of the disclosure are described in more detail below with reference to the drawings. It may be understood that any one of the following examples in Example I to Example VIII is applicable to all embodiments of the disclosure.

For ease of description, in the following examples, STO indicates a surface of a diaphragm; IMG indicates an image surface of the visual optical lens assembly 10; f indicates the effective focal length of the visual optical lens assembly 10; ImgH indicates an imaging height of the visual optical lens assembly 10; EPD indicates the EPD of the visual optical lens assembly 10; fi is used to indicate an effective focal length of an ith lens, where i=1, 2, 3; and Aj is used to indicate jth-order Aspheric coefficient, where j=2, 4, 6, 8, 10, 12, 14.

Furthermore, surface numbers of function surfaces of light route are sequentially defined as S1 to SN in an opposite direction of the light path; S1 indicates the surface number of the first function surface of the light route in the opposite direction of the light path; and SN indicates the surface number of the Nth function surface of the light route in the opposite direction of the light path. For example, as shown in FIG. 2, S1 indicates the object-side surface of the first lens 11; S2 indicates the image-side surface (i.e., an interface between the first lens 11 and the glue coating layer 17) of the first lens 11; S3 indicates a function surface (i.e., an interface between the reflective polarizing element 12 and the glue coating layer 17) provided by the reflective polarizing element 12; S4 indicates the object-side surface (i.e., an interface between the second lens 13 and the reflective polarizing element 12) of the second lens 13; S5 indicates the image-side surface (i.e., an interface between the second lens 13 and the glue coating layer 17) of the second lens 13; S6 indicates a function surface (i.e., an interface between the quarter-wave plate 14 and the glue coating layer 17) provided by the quarter-wave plate 14; S7 indicates the object-side surface (i.e., an interface between the third lens 15 and the quarter-wave plate 14) of the third lens 15; S8 indicates the image-side surface (i.e., an interface between the third lens 15 and the partially-reflective element 16) of the third lens 15; S9 indicates a function surface (i.e., an interface between the quarter-wave plate 14 and the third lens 15) provided by the quarter-wave plate 14; S10 indicates a function surface (i.e., an interface between the quarter-wave plate 14 and the glue coating layer 17) provided by the glue coating layer 17 coated on the second lens 13; S11 indicates the image-side surface (i.e., an interface between the second lens 13 and the glue coating layer 17) of the second lens 13; S12 indicates the object-side surface (i.e., the interface between the second lens 13 and the reflective polarizing element 12) of the second lens 13; S13 indicates the function surface (i.e., the interface between the reflective polarizing element 12 and the glue coating layer 17) provided by the reflective polarizing element 12; S14 indicates the object-side surface (i.e., the interface between the second lens 13 and the reflective polarizing element 12) of the second lens 13; S15 indicates the image-side surface (i.e., the interface between the second lens 13 and the glue coating layer 17) of the second lens 13; S16 indicates the function surface (i.e., the interface between the quarter-wave plate 14 and the glue coating layer 17) provided by the quarter-wave plate 14; S17 indicates the object-side surface (i.e., the interface between the third lens 15 and the quarter-wave plate 14) of the third lens 15; S18 indicates the image-side surface (i.e., the interface between the third lens 15 and the partially-reflective element 16) of the third lens 15; S19 indicates an object-side surface of the protection element 18; and S20 indicates the imaging surface IMG of the visual optical lens assembly 10.

### Example I

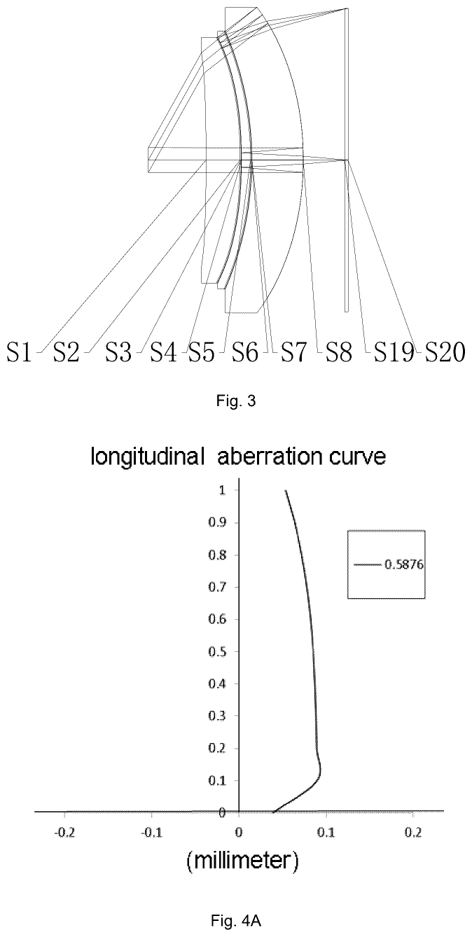

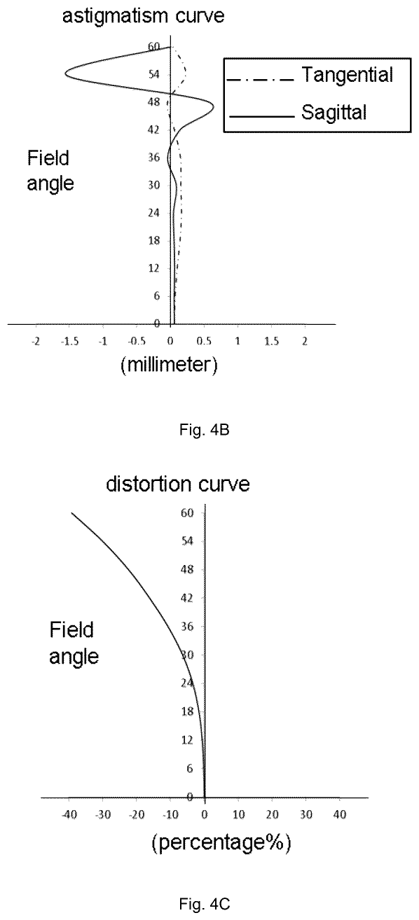

As shown in FIGS. 3 to 4C, the visual optical lens assembly 10 of Example I is described. In particular, as shown in FIG. 3, in the visual optical lens assembly 10 of Example I, the protection element 18 is directly attached to the light source surface 200 of the screen 20, so as to cause the image-side surface of the protection element 18 to coincide with the imaging surface IMG, that is, S20 indicates an interface between the protection element 18 and the screen 20. Based on the above relational expression, Table 1 and Table 2 show design data of the visual optical lens assembly 10 of Example I.

In particular, Table 1 shows basic optical parameters of the visual optical lens assembly 10 of Example I; and Table 2 shows an Aspheric coefficient table of lens assemblies in the visual optical lens assembly 10 of Example I.

TABLE 1
Basic optical parameters of visual optical lens assembly of Example I

| | Surface | Surface | | Curvature | | | | | | Refraction | | Effective |
|---|---|---|---|---|---|---|---|---|---|---|---|---|
| | number | type | | radius | | Thickness | | Material | | mode | | radius |
| STO | | Spherical | | Infinite | | 12 | | | | | | 2 |
| | | surface | | | | | | | | | | |
| REFL1 | S1 | Aspheric | R1 | −847.2145 | CT1 | 7.0792 | N1V1 | 1.54 | 55.9 | Refraction | DT11 | 21.3989 |
| | | surface | | | | | | | | | | |
| glue | S2 | Aspheric | R2 | −105.3797 | glue | 0.2000 | | | | Refraction | DT12 | 24.2789 |
| | | surface | | | | | | | | | | |
| RP | S3 | Aspheric | | −105.3797 | CTRP | 0.0880 | NRPVRP | 1.50 | 57.0 | Refraction | | 24.3930 |
| | | surface | | | | | | | | | | |
| REFL2 | S4 | Aspheric | R3 | −105.3797 | CT2 | 1.8756 | N2V2 | 1.54 | 55.9 | Refraction | DT21 | 24.4436 |
| | | surface | | | | | | | | | | |
| glue | S5 | Spherical | R4 | −64.0000 | glue | 0.2000 | | | | Refraction | DT22 | 25.5208 |
| | | surface | | | | | | | | | | |
| QWP | S6 | Spherical | | −64.0000 | CTQWP | 0.0880 | NQWPVQWP | 1.50 | 57.0 | Refraction | | 25.6393 |
| | | surface | | | | | | | | | | |
| REFL3 | S7 | Spherical | R5 | −64.0000 | CT3 | 10.6760 | N3V3 | 1.54 | 55.9 | Refraction | DT31 | 25.6920 |
| | | surface | | | | | | | | | | |
| BS | S8 | Aspheric | R6 | −62.8333 | CT3 | −10.6760 | | | | Reflection | DT32 | 30.8254 |
| | | surface | | | | | | | | | | |
| QWP | S9 | Spherical | | −64.0000 | CTQWP | −0.0880 | | | | Refraction | | 25.9811 |
| | | surface | | | | | | | | | | |
| glue | S10 | Spherical | | −64.0000 | glue | −0.2000 | | | | Refraction | | 25.9316 |
| | | surface | | | | | | | | | | |
| REFL2 | S11 | Spherical | R4 | −64.0000 | CT2 | −1.8756 | N2V2 | 1.54 | 55.9 | Refraction | DT21 | 25.8202 |
| | | surface | | | | | | | | | | |
| | S12 | Aspheric | R3 | −105.3797 | CTRP | −0.0880 | | | | Refraction | DT22 | 24.7902 |
| | | surface | | | | | | | | | | |
| RP | S13 | Aspheric | | −105.3797 | CTRP | 0.088 | | | | Reflection | | 24.7427 |
| | | surface | | | | | | | | | | |
| REFL2 | S14 | Aspheric | R3 | −105.3797 | CT2 | 1.87555702 | N2V2 | 1.54 | 55.9 | Refraction | DT21 | 24.7663 |
| | | surface | | | | | | | | | | |
| glue | S15 | Spherical | R4 | −64.0000 | glue | 0.2 | | | | Refraction | DT22 | 25.2793 |
| | | surface | | | | | | | | | | |
| QWP | S16 | Spherical | | −64.0000 | CTQWP | 0.088 | | | | Refraction | | 25.3352 |
| | | surface | | | | | | | | | | |
| REFL3 | S17 | Spherical | R5 | −64.0000 | CT3 | 10.6759615 | N3V3 | 1.54 | 55.9 | Refraction | DT31 | 25.3595 |
| | | surface | | | | | | | | | | |
| BS | S18 | Aspheric | R6 | −62.8333 | | 8.62243888 | | | | Refraction | DT32 | 27.9923 |
| | | surface | | | | | | | | | | |
| FI | S19 | Spherical | | | | 0.7 | | 1.52 | 64.2 | Refraction | | 32.3345 |
| | | surface | | | | | | | | | | |
| IMG | S20 | | | | | 0 | | | | Refraction | | 40.4059 |

It is to be noted that, in the above table, STO indicates the diaphragm; REFL1 indicates the first lens 11; glue indicates the glue coating layer 17; RP indicates the reflective polarizing element 12; REFL2 indicates the second lens 13; QWP indicates the quarter-wave plate 14; REFL3 indicates the third lens 15; BS indicates the partially-reflective element 16; and FI indicates the protection element 18. Furthermore, in the visual optical lens assembly 10 of Example I, TTL=29.53 mm; ImgH=30.58 mm; HFOV=600; BFL=9.32 mm; f1=−2404.82 mm; f2=−3704.26 mm; f3=−31.71 mm; f=44.25 mm.

TABLE 2
Aspheric coefficient table of lens assemblies in visual optical lens assembly of Example I

| Surface number | A2 | A4 | A6 | A8 | A10 | A12 | A14 |
|---|---|---|---|---|---|---|---|
| S1 | −1.762E−05 | 1.788E−07 | −8.9114E−10 | 2.2875E−12 | −3.1969E−15 | 2.3231E−18 | −6.9018E−22 |
| S2 | −1.07E−05 | 4.8675E−09 | 1.5137E−10 | −5.9387E−13 | 9.4583E−16 | −6.9235E−19 | 1.9396E−22 |
| S3 | −1.07E−05 | 4.8675E−09 | 1.5137E−10 | −5.9387E−13 | 9.4583E−16 | −6.9235E−19 | 1.9396E−22 |
| S4 | −1.07E−05 | 4.8675E−09 | 1.5137E−10 | −5.9387E−13 | 9.4583E−16 | −6.9235E−19 | 1.9396E−22 |
| S8 | −4.091E−06 | 5.8877E−09 | 3.3147E−12 | −2.2781E−14 | 2.4465E−17 | −9.7717E−21 | 1.1369E−24 |
| S12 | −1.07E−05 | 4.8675E−09 | 1.5137E−10 | −5.9387E−13 | 9.4583E−16 | −6.9235E−19 | 1.9396E−22 |
| S13 | −1.07E−05 | 4.8675E−09 | 1.5137E−10 | −5.9387E−13 | 9.4583E−16 | −6.9235E−19 | 1.9396E−22 |
| S14 | −1.07E−05 | 4.8675E−09 | 1.5137E−10 | −5.9387E−13 | 9.4583E−16 | −6.9235E−19 | 1.9396E−22 |
| S18 | −4.091E−06 | 5.8877E−09 | 3.3147E−12 | −2.2781E−14 | 2.4465E−17 | −9.7717E−21 | 1.1369E−24 |

The following may be obtained through a simulation test, a longitudinal aberration curve of the visual optical lens assembly 10 of Example I is shown in FIG. 4A; an astigmatism curve of the visual optical lens assembly 10 of Example I is shown in FIG. 4B; and a distortion curve of the visual optical lens assembly 10 of Example I is shown in FIG. 4C. According to FIG. 4A to FIG. 4C, it may be learned that, the visual optical lens assembly of Example I can achieve desirable imaging quality.

### Example II

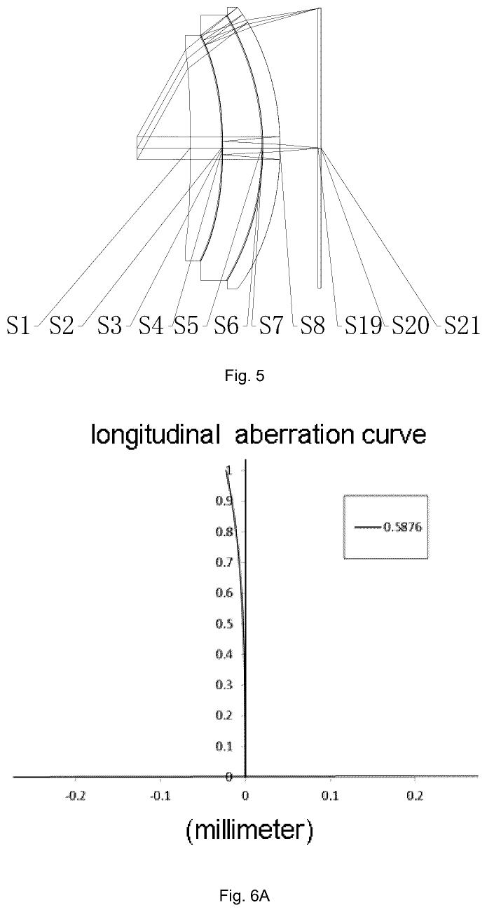

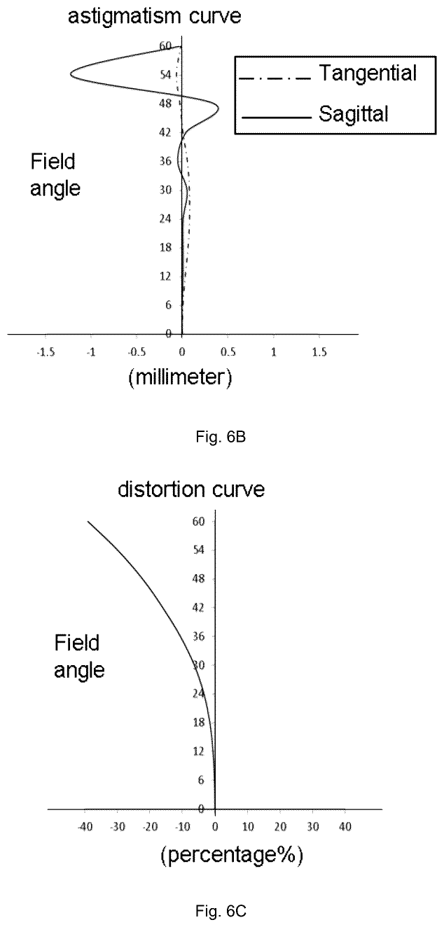

As shown in FIGS. 5 to 6C, the visual optical lens assembly 10 of Example II is described. In particular, as shown in FIG. 5, in the visual optical lens assembly 10 of Example II, the protection element 18 is glued to the light source surface 200 of the screen 20, so as to cause the image-side surface of the protection element 18 and the imaging surface IMG to be arranged at intervals. In this case, the glue coating layer 17 may be disposed between the protection element 18 and the screen 20. S19 indicates the object-side surface of the protection element 18; S20 indicates the image-side surface (i.e., an interface between the protection element 18 and the glue coating layer 17) of the protection element 18; and S21 indicates the imaging surface IMG (i.e., an interface between the screen 20 and the glue coating layer 17) of the visual optical lens assembly 10. Based on the above relational expression, Table 3 and Table 4 show design data of the visual optical lens assembly 10 of Example II.

In particular, Table 3 shows basic optical parameters of the visual optical lens assembly 10 of Example II; and Table 4 shows an Aspheric coefficient table of lens assemblies in the visual optical lens assembly 10 of Example II.

TABLE 3
Basic optical parameters of visual optical lens assembly of Example II

| | Surface | Surface | | Curvature | | | | | | Refraction | | Effective |
|---|---|---|---|---|---|---|---|---|---|---|---|---|
| | number | type | | radius | | Thickness | | Material | | mode | | radius |
| STO | | Spherical | | Infinite | | 12 | | | | | | 2 |
| | | surface | | | | | | | | | | |
| REFL1 | S1 | Aspheric | R1 | −508.5559 | CT1 | 7.0287 | N1V1 | 1.57 | 59.45 | Refraction | DT11 | 21.0377 |
| | | surface | | | | | | | | | | |
| glue | S2 | Aspheric | R2 | −103.0692 | glue | 0.2000 | | | | Refraction | DT12 | 24.1109 |
| | | surface | | | | | | | | | | |
| RP | S3 | Aspheric | | −103.0692 | CTRP | 0.0880 | NRP | 1.50 | 56.99 | Refraction | | 24.2243 |
| | | surface | | | | | VRP | | | | | |
| REFL2 | S4 | Aspheric | R3 | −103.0692 | CT2 | 8.8000 | N2V2 | 1.55 | 57.05 | Refraction | DT21 | 24.2749 |
| | | surface | | | | | | | | | | |
| glue | S5 | Spherical | R4 | −56.0000 | glue | 0.2000 | | | | Refraction | DT22 | 28.7398 |
| | | surface | | | | | | | | | | |
| QWP | S6 | Spherical | | −56.0000 | CTQWP | 0.0880 | NQWPV | 1.50 | 56.99 | Refraction | | 28.8473 |
| | | surface | | | | | QWP | | | | | |
| REFL3 | S7 | Spherical | R5 | −56.0000 | CT3 | 3.8264 | N3V3 | 1.54 | 53.58 | Refraction | DT31 | 28.8949 |
| | | surface | | | | | | | | | | |
| BS | S8 | Aspheric | R6 | −62.4779 | CT3 | −3.8264 | | | | Reflection | DT32 | 30.7147 |
| | | surface | | | | | | | | | | |
| QWP | S9 | Spherical | | −56.0000 | CTQWP | −0.0880 | | | | Refraction | | 28.9970 |
| | | surface | | | | | | | | | | |
| glue | S10 | Spherical | | −56.0000 | glue | −0.2000 | | | | Refraction | | 28.9522 |
| | | surface | | | | | | | | | | |
| REFL2 | S11 | Spherical | R4 | −56.0000 | CT2 | −8.8000 | N2V2 | 1.55 | 57.05 | Refraction | DT21 | 28.8508 |
| | | surface | | | | | | | | | | |
| | S12 | Aspheric | R3 | −103.0692 | CTRP | −0.0880 | | | | Refraction | DT22 | 24.6530 |
| | | surface | | | | | | | | | | |
| RP | S13 | Aspheric | | −103.0692 | CTRP | 0.088 | | | | Reflection | | 24.6057 |
| | | surface | | | | | | | | | | |
| REFL2 | S14 | Aspheric | R3 | −103.0692 | CT2 | 8.8 | N2V2 | 1.55 | 57.05 | Refraction | DT21 | 24.6295 |
| | | surface | | | | | | | | | | |
| glue | S15 | Spherical | R4 | −56.0000 | glue | 0.2 | | | | Refraction | DT22 | 26.8326 |
| | | surface | | | | | | | | | | |
| QWP | S16 | Spherical | | −56.0000 | CTQWP | 0.088 | | | | Refraction | | 26.8876 |
| | | surface | | | | | | | | | | |
| REFL3 | S17 | Spherical | R5 | −56.0000 | CT3 | 3.82644174 | N3V3 | 1.54 | 53.58 | Refraction | DT31 | 26.9111 |
| | | surface | | | | | | | | | | |
| BS | S18 | Aspheric | R6 | −62.4779 | | 8.53779758 | | | | Refraction | DT32 | 27.9073 |
| | | surface | | | | | | | | | | |
| FI | S19 | Spherical | | | | 0.7 | | 1.52 | 64.17 | Refraction | | 30.4605 |
| | | surface | | | | | | | | | | |
| | S20 | Spherical | | | | 0.05891626 | | | | Refraction | | 30.5646 |
| | | surface | | | | | | | | | | |
| IMG | S21 | Spherical | | | | 0 | | | | Refraction | | 30.5806 |
| | | surface | | | | | | | | | | |

It is to be noted that, in the above table, STO indicates the diaphragm; REFL1 indicates the first lens 11; glue indicates the glue coating layer 17; RP indicates the reflective polarizing element 12; REFL2 indicates the second lens 13; QWP indicates the quarter-wave plate 14; REFL3 indicates the third lens 15; BS indicates the partially-reflective element 16; and FI indicates the protection element 18. Furthermore, in the visual optical lens assembly 10 of Example II, TTL-29.53 mm; ImgH-30.56 mm; HFOV=60°; BFL=9.30 mm; f1=−1394.00 mm; f2=−1726.67 mm; f3=−31.62 mm; f=29.11 mm.

TABLE 4
Aspheric coefficient table of lens assemblies in visual optical lens assembly of Example II

| Surface | | | | | | | |
|---|---|---|---|---|---|---|---|
| number | A2 | A4 | A6 | A8 | A10 | A12 | A14 |
| S1 | −1.762E−05 | 1.788E−07 | −8.9114E−10 | 2.2875E−12 | −3.1969E−15 | 2.3231E−18 | −6.9018E−22 |
| S2 | −1.07E−05 | 4.8675E−09 | 1.5137E−10 | −5.9387E−13 | 9.4583E−16 | −6.9235E−19 | 1.9396E−22 |
| S3 | −1.07E−05 | 4.8675E−09 | 1.5137E−10 | −5.9387E−13 | 9.4583E−16 | −6.9235E−19 | 1.9396E−22 |
| S4 | −1.07E−05 | 4.8675E−09 | 1.5137E−10 | −5.9387E−13 | 9.4583E−16 | −6.9235E−19 | 1.9396E−22 |
| S8 | −4.091E−06 | 5.8877E−09 | 3.3147E−12 | −2.2781E−14 | 2.4465E−17 | −9.7717E−21 | 1.1369E−24 |
| S12 | −1.07E−05 | 4.8675E−09 | 1.5137E−10 | −5.9387E−13 | 9.4583E−16 | −6.9235E−19 | 1.9396E−22 |
| S13 | −1.07E−05 | 4.8675E−09 | 1.5137E−10 | −5.9387E−13 | 9.4583E−16 | −6.9235E−19 | 1.9396E−22 |
| S14 | −1.07E−05 | 4.8675E−09 | 1.5137E−10 | −5.9387E−13 | 9.4583E−16 | −6.9235E−19 | 1.9396E−22 |
| S18 | −4.091E−06 | 5.8877E−09 | 3.3147E−12 | −2.2781E−14 | 2.4465E−17 | −9.7717E−21 | 1.1369E−24 |

The following may be obtained through a simulation test, a longitudinal aberration curve of the visual optical lens assembly 10 of Example II is shown in FIG. 6A; an astigmatism curve of the visual optical lens assembly 10 of Example II is shown in FIG. 6B; and a distortion curve of the visual optical lens assembly 10 of Example II is shown in FIG. 6C. According to FIG. 6A to FIG. 6C, it may be learned that, the visual optical lens assembly of Example II can achieve desirable imaging quality.

### Example III

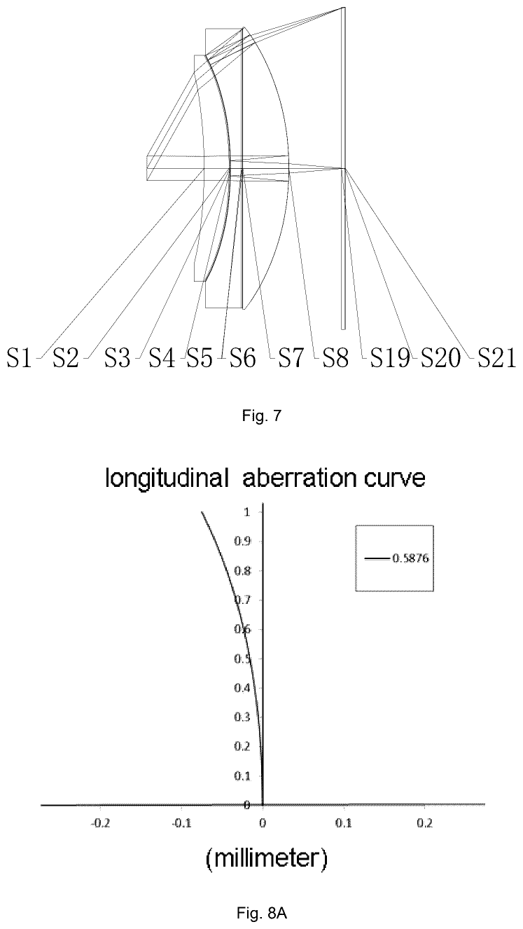

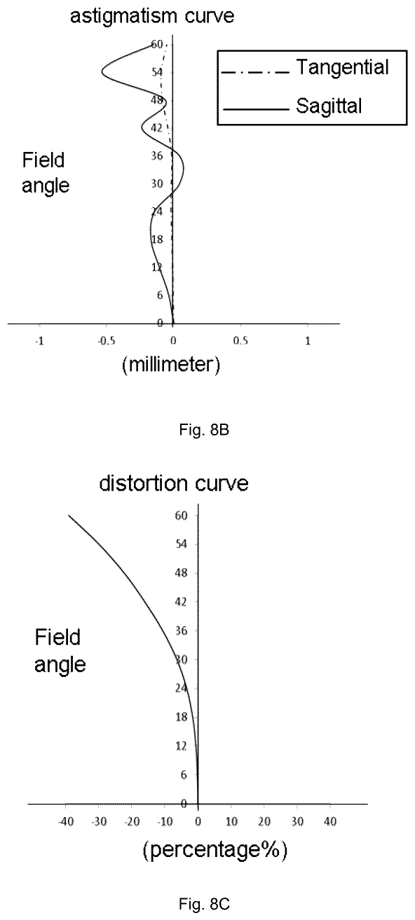

As shown in FIGS. 7 to 8C, the visual optical lens assembly 10 of Example III is described. In particular, as shown in FIG. 7, in the visual optical lens assembly 10 of Example III, the protection element 18 is glued to the light source surface 200 of the screen 20, so as to cause the image-side surface of the protection element 18 and the imaging surface IMG to be arranged at intervals. In this case, the glue coating layer 17 may be disposed between the protection element 18 and the screen 20. S19 indicates the object-side surface of the protection element 18; S20 indicates the image-side surface (i.e., an interface between the protection element 18 and the glue coating layer 17) of the protection element 18; and S21 indicates the imaging surface IMG (i.e., an interface between the screen 20 and the glue coating layer 17) of the visual optical lens assembly 10. Based on the above relational expression, Table 5 and Table 6 show design data of the visual optical lens assembly 10 of Example III.

In particular, Table 5 shows basic optical parameters of the visual optical lens assembly 10 of Example III; and Table 6 shows an Aspheric coefficient table of lens assemblies in the visual optical lens assembly 10 of Example III.

TABLE 5
Basic optical parameters of visual optical lens assembly of Example III

| | Surface | Surface | | Curvature | | | | | | Refraction | | Effective |
|---|---|---|---|---|---|---|---|---|---|---|---|---|
| | number | type | | radius | | Thickness | | Material | | mode | | radius |
| STO | | Spherical | | Infinite | | 12 | | | | | | 2 |
| | | surface | | | | | | | | | | |
| REFL1 | S1 | Aspheric | R1 | −108.0000 | CT1 | 5.2327 | N1V1 | 1.59 | 61.65 | Refraction | DT11 | 19.2408 |
| | | surface | | | | | | | | | | |
| glue | S2 | Aspheric | R2 | −75.1663 | glue | 0.2000 | | | | Refraction | DT12 | 21.9824 |
| | | surface | | | | | | | | | | |
| RP | S3 | Aspheric | | −75.1663 | CTRP | 0.0880 | NRP | 1.50 | 56.99 | Refraction | | 22.1023 |
| | | surface | | | | | VRP | | | | | |
| REFL2 | S4 | Aspheric | R3 | −75.1663 | CT2 | 2.3072 | N2V2 | 1.59 | 61.65 | Refraction | DT21 | 22.1560 |
| | | surface | | | | | | | | | | |
| glue | S5 | Spherical | R4 | −81233.6866 | glue | 0.2000 | | | | Refraction | DT22 | 28.2264 |
| | | surface | | | | | | | | | | |
| QWP | S6 | Spherical | | −81233.6866 | CTQWP | 0.0880 | NQWP | 1.50 | 56.99 | Refraction | | 28.4000 |
| | | surface | | | | | VQWP | | | | | |
| REFL3 | S7 | Spherical | R5 | −81233.6866 | CT3 | 9.6806 | N3V3 | 1.59 | 61.65 | Refraction | DT31 | 28.4851 |
| | | surface | | | | | | | | | | |
| BS | S8 | Aspheric | R6 | −55.4906 | CT3 | −9.6806 | | | | Reflection | DT32 | 28.8476 |
| | | surface | | | | | | | | | | |
| QWP | S9 | Spherical | | −81233.6866 | CTQWP | −0.0880 | | | | Refraction | | 28.5559 |
| | | surface | | | | | | | | | | |
| glue | S10 | Spherical | | −81233.6866 | glue | −0.2000 | | | | Refraction | | 28.4887 |
| | | surface | | | | | | | | | | |
| REFL2 | S11 | Spherical | R4 | −81233.6866 | CT2 | −2.3072 | N2V2 | 1.59 | 61.65 | Refraction | DT21 | 28.3491 |
| | | surface | | | | | | | | | | |
| | S12 | Aspheric | R3 | −75.1663 | CTRP | −0.0880 | | | | Refraction | DT22 | 23.1064 |
| | | surface | | | | | | | | | | |
| RP | S13 | Aspheric | | −75.1663 | CTRP | 0.088 | | | | Reflection | | 23.0618 |
| | | surface | | | | | | | | | | |
| REFL2 | S14 | Aspheric | R3 | −75.1663 | CT2 | 2.3072482 | N2V2 | 1.59 | 61.65 | Refraction | DT21 | 23.0921 |
| | | surface | | | | | | | | | | |
| glue | S15 | Spherical | R4 | −81233.6866 | glue | 0.2 | | | | Refraction | DT22 | 26.3371 |
| | | surface | | | | | | | | | | |
| QWP | S16 | Spherical | | −81233.6866 | CTQWP | 0.088 | | | | Refraction | | 26.4236 |
| | | surface | | | | | | | | | | |
| REFL3 | S17 | Spherical | R5 | −81233.6866 | CT3 | 9.68057762 | N3V3 | 1.59 | 61.65 | Refraction | DT31 | 26.4644 |
| | | surface | | | | | | | | | | |
| BS | S18 | Aspheric | R6 | −55.4906 | | 11.0325638 | | | | Refraction | DT32 | 27.1789 |
| | | surface | | | | | | | | | | |
| FI | S19 | Spherical | | | | 0.7 | | 1.52 | 64.17 | Refraction | | 32.3345 |
| | | surface | | | | | | | | | | |
| | S20 | Spherical | | | | 0.13849744 | | | | Refraction | | 32.9216 |
| | | surface | | | | | | | | | | |
| IMG | S21 | Spherical | | | | 0 | | | | Refraction | | 40.4059 |
| | | surface | | | | | | | | | | |

It is to be noted that, in the above table, STO indicates the diaphragm; REFL1 indicates the first lens 11; glue indicates the glue coating layer 17; RP indicates the reflective polarizing element 12; REFL2 indicates the second lens 13; QWP indicates the quarter-wave plate 14; REFL3 indicates the third lens 15; BS indicates the partially-reflective element 16; and FI indicates the protection element 18. Furthermore, in the visual optical lens assembly 10 of Example III, TTL-29.67 mm; ImgH-32.95 mm; HFOV=60°; BFL=11.87 mm; f1=−291.05 mm; f2=−1327.94 mm; f3=−27.75 mm; f=30.30 mm.

TABLE 6
Aspheric coefficient table of lens assemblies in visual optical lens assembly of Example III

| Surface | | | | | | | |
|---|---|---|---|---|---|---|---|
| number | A2 | A4 | A6 | A8 | A10 | A12 | A14 |
| S1 | −1.762E−05 | 1.788E−07 | −8.9114E−10 | 2.2875E−12 | −3.1969E−15 | 2.3231E−18 | −6.9018E−22 |
| S2 | −1.07E−05 | 4.8675E−09 | 1.5137E−10 | −5.9387E−13 | 9.4583E−16 | −6.9235E−19 | 1.9396E−22 |
| S3 | −1.07E−05 | 4.8675E−09 | 1.5137E−10 | −5.9387E−13 | 9.4583E−16 | −6.9235E−19 | 1.9396E−22 |
| S4 | −1.07E−05 | 4.8675E−09 | 1.5137E−10 | −5.9387E−13 | 9.4583E−16 | −6.9235E−19 | 1.9396E−22 |
| S8 | −4.091E−06 | 5.8877E−09 | 3.3147E−12 | −2.2781E−14 | 2.4465E−17 | −9.7717E−21 | 1.1369E−24 |
| S12 | −1.07E−05 | 4.8675E−09 | 1.5137E−10 | −5.9387E−13 | 9.4583E−16 | −6.9235E−19 | 1.9396E−22 |
| S13 | −1.07E−05 | 4.8675E−09 | 1.5137E−10 | −5.9387E−13 | 9.4583E−16 | −6.9235E−19 | 1.9396E−22 |
| S14 | −1.07E−05 | 4.8675E−09 | 1.5137E−10 | −5.9387E−13 | 9.4583E−16 | −6.9235E−19 | 1.9396E−22 |
| S18 | −4.091E−06 | 5.8877E−09 | 3.3147E−12 | −2.2781E−14 | 2.4465E−17 | −9.7717E−21 | 1.1369E−24 |

The following may be obtained through a simulation test, a longitudinal aberration curve of the visual optical lens assembly 10 of Example III is shown in FIG. 8A; an astigmatism curve of the visual optical lens assembly 10 of Example III is shown in FIG. 8B; and a distortion curve of the visual optical lens assembly 10 of Example III is shown in FIG. 8C. According to FIG. 8A to FIG. 8C, it may be learned that, the visual optical lens assembly of Example III can achieve desirable imaging quality.

### Example IV

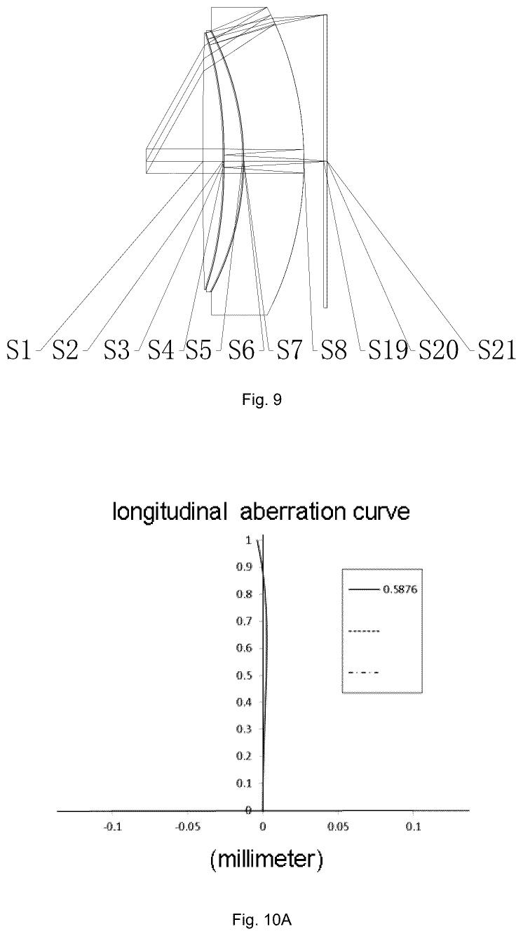

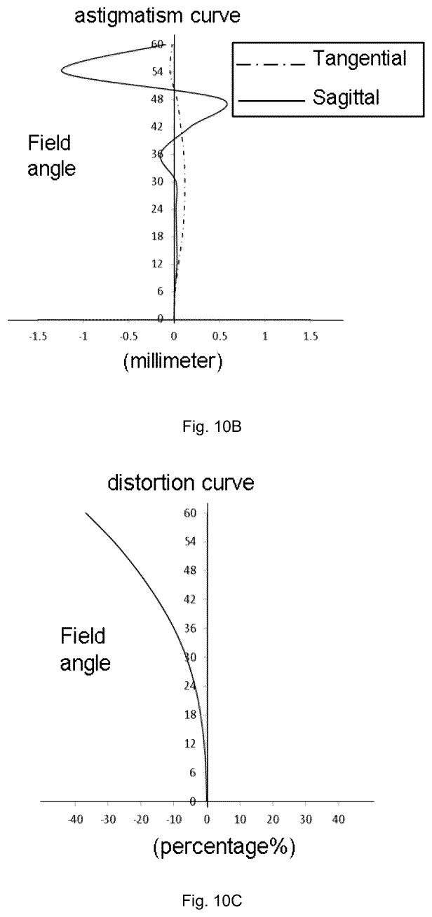

As shown in FIGS. 9 to 10C, the visual optical lens assembly 10 of Example IV is described. In particular, as shown in FIG. 9, in the visual optical lens assembly 10 of Example IV, the protection element 18 is glued to the light source surface 200 of the screen 20, so as to cause the image-side surface of the protection element 18 and the imaging surface IMG to be arranged at intervals. In this case, the glue coating layer 17 may be disposed between the protection element 18 and the screen 20. S19 indicates the object-side surface of the protection element 18; S20 indicates the image-side surface (i.e., an interface between the protection element 18 and the glue coating layer 17) of the protection element 18; and S21 indicates the imaging surface IMG (i.e., an interface between the screen 20 and the glue coating layer 17) of the visual optical lens assembly 10. Based on the above relational expression, Table 7 and Table 8 show design data of the visual optical lens assembly 10 of Example IV.

In particular, Table 7 shows basic optical parameters of the visual optical lens assembly 10 of Example IV; and Table 8 shows an Aspheric coefficient table of lens assemblies in the visual optical lens assembly 10 of Example IV.

TABLE 7
Basic optical parameters of visual optical lens assembly of Example IV

| | Surface | Surface | | Curvature | | | | | | Refraction | | Effective |
|---|---|---|---|---|---|---|---|---|---|---|---|---|
| | number | type | | radius | | Thickness | | Material | | mode | | radius |
| STO | | Spherical | | Infinite | | 12 | | | | | | 2 |
| | | surface | | | | | | | | | | |
| REFL1 | S1 | Aspheric | R1 | 1053.8634 | CT1 | 4.1844 | N1V1 | 1.59 | 52.25 | Refraction | DT11 | 23.2030 |
| | | surface | | | | | | | | | | |
| glue | S2 | Aspheric | R2 | −153.1064 | glue | 0.2000 | | | | Refraction | DT12 | 24.1696 |
| | | surface | | | | | | | | | | |
| RP | S3 | Aspheric | | −153.1064 | CTRP | 0.0880 | NRP | 1.50 | 56.99 | Refraction | | 24.2702 |
| | | surface | | | | | VRP | | | | | |
| REFL2 | S4 | Aspheric | R3 | −153.1064 | CT2 | 3.8536 | N2V2 | 1.59 | 58.42 | Refraction | DT21 | 24.3156 |
| | | surface | | | | | | | | | | |
| glue | S5 | Spherical | R4 | −56.0000 | glue | 0.2000 | | | | Refraction | DT22 | 24.9999 |
| | | surface | | | | | | | | | | |
| QWP | S6 | Spherical | | −56.0000 | CTQWP | 0.0880 | NQWPV | 1.50 | 56.99 | Refraction | | 25.0918 |
| | | surface | | | | | QWP | | | | | |
| REFL3 | S7 | Spherical | R5 | −56.0000 | CT3 | 12.6594 | N3V3 | 1.58 | 60.16 | Refraction | DT31 | 25.1324 |
| | | surface | | | | | | | | | | |
| BS | S8 | Aspheric | R6 | −73.5711 | CT3 | −12.6594 | | | | Reflection | DT32 | 31.6088 |
| | | surface | | | | | | | | | | |
| QWP | S9 | Spherical | | −56.0000 | CTQWP | −0.0880 | | | | Refraction | | 26.8081 |
| | | surface | | | | | | | | | | |
| glue | S10 | Spherical | | −56.0000 | glue | −0.2000 | | | | Refraction | | 26.7791 |
| | | surface | | | | | | | | | | |
| REFL2 | S11 | Spherical | R4 | −56.0000 | CT2 | −3.8536 | N2V2 | 1.59 | 58.42 | Refraction | DT21 | 26.7121 |
| | | surface | | | | | | | | | | |
| | S12 | Aspheric | R3 | −153.1064 | CTRP | −0.0880 | | | | Refraction | DT22 | 26.3461 |
| | | surface | | | | | | | | | | |
| RP | S13 | Aspheric | | −153.1064 | CTRP | 0.088 | | | | Reflection | | 26.3137 |
| | | surface | | | | | | | | | | |
| REFL2 | S14 | Aspheric | R3 | −153.1064 | CT2 | 3.85355277 | N2V2 | 1.59 | 58.42 | Refraction | DT21 | 26.3312 |
| | | surface | | | | | | | | | | |
| glue | S15 | Spherical | R4 | −56.0000 | glue | 0.2 | | | | Refraction | DT22 | 26.5433 |
| | | surface | | | | | | | | | | |
| QWP | S16 | Spherical | | −56.0000 | CTQWP | 0.088 | | | | Refraction | | 26.5821 |
| | | surface | | | | | | | | | | |
| REFL3 | S17 | Spherical | R5 | −56.0000 | CT3 | 12.6593926 | N3V3 | 1.58 | 60.16 | Refraction | DT31 | 26.5979 |
| | | surface | | | | | | | | | | |
| BS | S18 | Aspheric | R6 | −73.5711 | | 4.17918006 | | | | Refraction | DT32 | 29.3382 |
| | | surface | | | | | | | | | | |
| FI | S19 | Spherical | | | | 0.7 | | 1.52 | 64.17 | Refraction | | 30.0378 |
| | | surface | | | | | | | | | | |
| | S20 | Spherical | | | | 0.04321393 | | | | Refraction | | 30.1059 |
| | | surface | | | | | | | | | | |
| IMG | S21 | Spherical | | | | 0 | | | | Refraction | | 30.1147 |
| | | surface | | | | | | | | | | |

It is to be noted that, in the above table, STO indicates the diaphragm; REFL1 indicates the first lens 11; glue indicates the glue coating layer 17; RP indicates the reflective polarizing element 12; REFL2 indicates the second lens 13; QWP indicates the quarter-wave plate 14; REFL3 indicates the third lens 15; BS indicates the partially-reflective element 16; and FI indicates the protection element 18. Furthermore, in the visual optical lens assembly 10 of Example IV, TTL-26.20 mm; ImgH-30.10 mm; HFOV=60°; BFL=4.92 mm; f1=2840.07 mm; f2=−2704.88 mm; f3=−37.62 mm; f=29.46 mm.

TABLE 8
Aspheric coefficient table of lens assemblies in visual optical lens assembly of Example IV

| Surface | | | | | | | |
|---|---|---|---|---|---|---|---|
| number | A2 | A4 | A6 | A8 | A10 | A12 | A14 |
| S1 | −1.487E−05 | 1.7923E−07 | −8.9173E−10 | 2.2871E−12 | −3.1967E−15 | 2.3245E−18 | −6.8690E−22 |
| S2 | −9.811E−06 | 5.8355E−09 | 1.5173E−10 | −5.9420E−13 | 9.4528E−16 | −6.9280E−19 | 1.9377E−22 |
| S3 | −9.811E−06 | 5.8355E−09 | 1.5173E−10 | −5.9420E−13 | 9.4528E−16 | −6.9280E−19 | 1.9377E−22 |
| S4 | −9.811E−06 | 5.8355E−09 | 1.5173E−10 | −5.9420E−13 | 9.4528E−16 | −6.9280E−19 | 1.9377E−22 |
| S8 | −3.723E−06 | 5.9053E−09 | 3.3286E−12 | −2.2620E−14 | 2.4560E−17 | −9.7540E−21 | 1.1142E−24 |
| S12 | −9.811E−06 | 5.8355E−09 | 1.5173E−10 | −5.9420E−13 | 9.4528E−16 | −6.9280E−19 | 1.9377E−22 |
| S13 | −9.811E−06 | 5.8355E−09 | 1.5173E−10 | −5.9420E−13 | 9.4528E−16 | −6.9280E−19 | 1.9377E−22 |
| S14 | −9.811E−06 | 5.8355E−09 | 1.5173E−10 | −5.9420E−13 | 9.4528E−16 | −6.9280E−19 | 1.9377E−22 |
| S18 | −3.723E−06 | 5.9053E−09 | 3.3286E−12 | −2.2620E−14 | 2.4560E−17 | −9.7540E−21 | 1.1142E−24 |

The following may be obtained through a simulation test, a longitudinal aberration curve of the visual optical lens assembly 10 of Example IV is shown in FIG. 10A; an astigmatism curve of the visual optical lens assembly 10 of Example IV is shown in FIG. 10B; and a distortion curve of the visual optical lens assembly 10 of Example IV is shown in FIG. 10C. According to FIG. 10A to FIG. 10C, it may be learned that, the visual optical lens assembly of Example IV can achieve desirable imaging quality.

### Example V

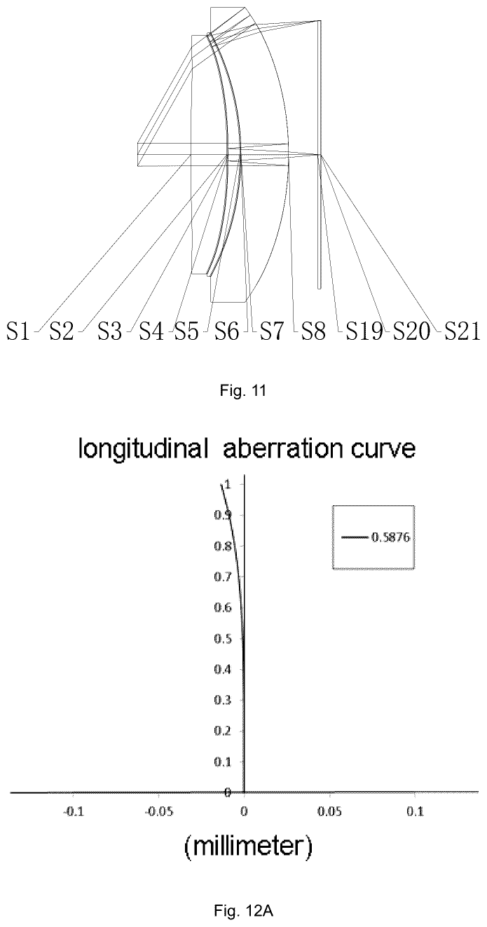

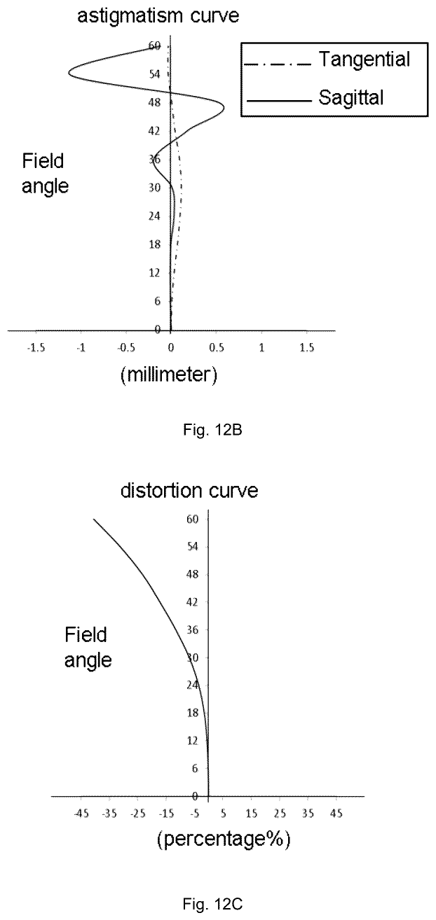

As shown in FIGS. 11 to 12C, the visual optical lens assembly 10 of Example Vis described. In particular, as shown in FIG. 11, in the visual optical lens assembly 10 of Example V, the protection element 18 is glued to the light source surface 200 of the screen 20, so as to cause the image-side surface of the protection element 18 and the imaging surface IMG to be arranged at intervals. In this case, the glue coating layer 17 may be disposed between the protection element 18 and the screen 20. S19 indicates the object-side surface of the protection element 18; S20 indicates the image-side surface (i.e., an interface between the protection element 18 and the glue coating layer 17) of the protection element 18; and S21 indicates the imaging surface IMG (i.e., an interface between the screen 20 and the glue coating layer 17) of the visual optical lens assembly 10. Based on the above relational expression, Table 9 and Table 10 show design data of the visual optical lens assembly 10 of Example V.

In particular, Table 9 shows basic optical parameters of the visual optical lens assembly 10 of Example V; and Table 10 shows an Aspheric coefficient table of lens assemblies in the visual optical lens assembly 10 of Example V.

TABLE 9
Basic optical parameters of visual optical lens assembly of Example V

| | Surface | Surface | | Curvature | | | | | | Refraction | | Effective |
|---|---|---|---|---|---|---|---|---|---|---|---|---|
| | number | type | | radius | | Thickness | | Material | | mode | | radius |
| STO | | Spherical | | Infinite | | 12 | | | | | | 2 |
| | | surface | | | | | | | | | | |
| REFL1 | S1 | Aspheric | R1 | 312.8045015 | CT1 | 8.1183 | N1V1 | 1.51 | 63.98 | Refraction | DT11 | 23.2033 |
| | | surface | | | | | | | | | | |
| glue | S2 | Aspheric | R2 | −135.84605 | glue | 0.2000 | | | | Refraction | DT12 | 26.0188 |
| | | surface | | | | | | | | | | |
| RP | S3 | Aspheric | | −135.84605 | CTRP | 0.0880 | NRP | 1.50 | 56.99 | Refraction | | 26.1273 |
| | | surface | | | | | VRP | | | | | |
| REFL2 | S4 | Aspheric | R3 | −135.8460 | | 2.6192 | | 1.51 | 63.98 | Refraction | DT21 | 26.1750 |
| | | surface | | | CT2 | | N2V2 | | | | | |
| glue | S5 | Spherical | R4 | −56.0000 | glue | 0.2000 | | | | Refraction | DT22 | 26.5984 |
| | | surface | | | | | | | | | | |
| QWP | S6 | Spherical | | −56.0000 | CTQWP | 0.0880 | NQWPV | 1.50 | 56.99 | Refraction | | 26.7028 |
| | | surface | | | | | QWP | | | | | |
| REFL3 | S7 | Spherical | R5 | −56.0000 | CT3 | 10.6767 | N3V3 | 1.51 | 64.11 | Refraction | DT31 | 26.7487 |
| | | surface | | | | | | | | | | |
| BS | S8 | Aspheric | R6 | −67.3856 | CT3 | −10.6767 | | | | Reflection | DT32 | 32.3512 |
| | | surface | | | | | | | | | | |
| QWP | S9 | Spherical | | −56.0000 | CTQWP | −0.0880 | | | | Refraction | | 26.6145 |
| | | surface | | | | | | | | | | |
| glue | S10 | Spherical | | −56.0000 | glue | −0.2000 | | | | Refraction | | 26.5673 |
| | | surface | | | | | | | | | | |
| REFL2 | S11 | Spherical | R4 | −56.0000 | CT2 | −2.6192 | N2V2 | 1.51 | 63.98 | Refraction | DT21 | 26.4602 |
| | | surface | | | | | | | | | | |
| | S12 | Aspheric | R3 | −135.8460 | CTRP | −0.0880 | | | | Refraction | DT22 | 26.0211 |
| | | surface | | | | | | | | | | |
| RP | S13 | Aspheric | | −135.8460 | CTRP | 0.088 | | | | Reflection | | 25.9721 |
| | | surface | | | | | | | | | | |
| REFL2 | S14 | Aspheric | R3 | −135.8460 | CT2 | 2.61917728 | N2V2 | 1.51 | 63.98 | Refraction | DT21 | 25.9906 |
| | | surface | | | | | | | | | | |
| glue | S15 | Spherical | R4 | −56.0000 | glue | 0.2 | | | | Refraction | DT22 | 26.1617 |
| | | surface | | | | | | | | | | |
| QWP | S16 | Spherical | | −56.0000 | CTQWP | 0.088 | | | | Refraction | | 26.2035 |
| | | surface | | | | | | | | | | |
| REFL3 | S17 | Spherical | R5 | −56.0000 | CT3 | 10.6767164 | N3V3 | 1.51 | 64.11 | Refraction | DT31 | 26.2218 |
| | | surface | | | | | | | | | | |
| BS | S18 | Aspheric | R6 | −67.3856 | | 6.54989115 | | | | Refraction | DT32 | 28.5630 |
| | | surface | | | | | | | | | | |
| FI | S19 | Spherical | | | | 0.7 | | 1.52 | 64.17 | Refraction | | 29.4087 |
| | | surface | | | | | | | | | | |
| | S20 | Spherical | | | | 0.04831396 | | | | Refraction | | 29.4571 |
| | | surface | | | | | | | | | | |
| IMG | S21 | Spherical | | | | 0 | | | | | | 29.4651 |
| | | surface | | | | | | | | | | |

It is to be noted that, in the above table, STO indicates the diaphragm; REFL1 indicates the first lens 11; glue indicates the glue coating layer 17; RP indicates the reflective polarizing element 12; REFL2 indicates the second lens 13; QWP indicates the quarter-wave plate 14; REFL3 indicates the third lens 15; BS indicates the partially-reflective element 16; and FI indicates the protection element 18. Furthermore, in the visual optical lens assembly 10 of Example V, TTL=29.29 mm; ImgH=29.46 mm; HFOV=600; BFL=7.30 mm; f1=926.15 mm; f2=−20512.75 mm; f3=−33.78 mm; f=28.70 mm.

TABLE 10
Aspheric coefficient table of lens assemblies in visual optical lens assembly of Example V

| Surface | | | | | | | |
|---|---|---|---|---|---|---|---|
| number | A2 | A4 | A6 | A8 | A10 | A12 | A14 |
| S1 | −1.581E−05 | 1.7712E−07 | −8.9186E−10 | 2.2879E−12 | −3.1955E−15 | 2.3249E−18 | −6.9161E−22 |
| S2 | −1.01E−05 | 5.9159E−09 | 1.5097E−10 | −5.9544E−13 | 9.4473E−16 | −6.9191E−19 | 1.9666E−22 |
| S3 | −1.01E−05 | 5.9159E−09 | 1.5097E−10 | −5.9544E−13 | 9.4473E−16 | −6.9191E−19 | 1.9666E−22 |
| S4 | −1.01E−05 | 5.9159E−09 | 1.5097E−10 | −5.9544E−13 | 9.4473E−16 | −6.9191E−19 | 1.9666E−22 |
| S8 | −4.004E−06 | 6.0311E−09 | 3.1100E−12 | −2.2744E−14 | 2.4493E−17 | −9.7791E−21 | 1.1141E−24 |
| S12 | −1.01E−05 | 5.9159E−09 | 1.5097E−10 | −5.9544E−13 | 9.4473E−16 | −6.9191E−19 | 1.9666E−22 |
| S13 | −1.01E−05 | 5.9159E−09 | 1.5097E−10 | −5.9544E−13 | 9.4473E−16 | −6.9191E−19 | 1.9666E−22 |
| S14 | −1.01E−05 | 5.9159E−09 | 1.5097E−10 | −5.9544E−13 | 9.4473E−16 | −6.9191E−19 | 1.9666E−22 |
| S18 | −4.004E−06 | 6.0311E−09 | 3.1100E−12 | −2.2744E−14 | 2.4493E−17 | −9.7791E−21 | 1.1141E−24 |

The following may be obtained through a simulation test, a longitudinal aberration curve of the visual optical lens assembly 10 of Example V is shown in FIG. 12A; an astigmatism curve of the visual optical lens assembly 10 of Example V is shown in FIG. 12B; and a distortion curve of the visual optical lens assembly 10 of Example V is shown in FIG. 12C. According to FIG. 12A to FIG. 12C, it may be learned that, the visual optical lens assembly of Example V can achieve desirable imaging quality.

### Example VI

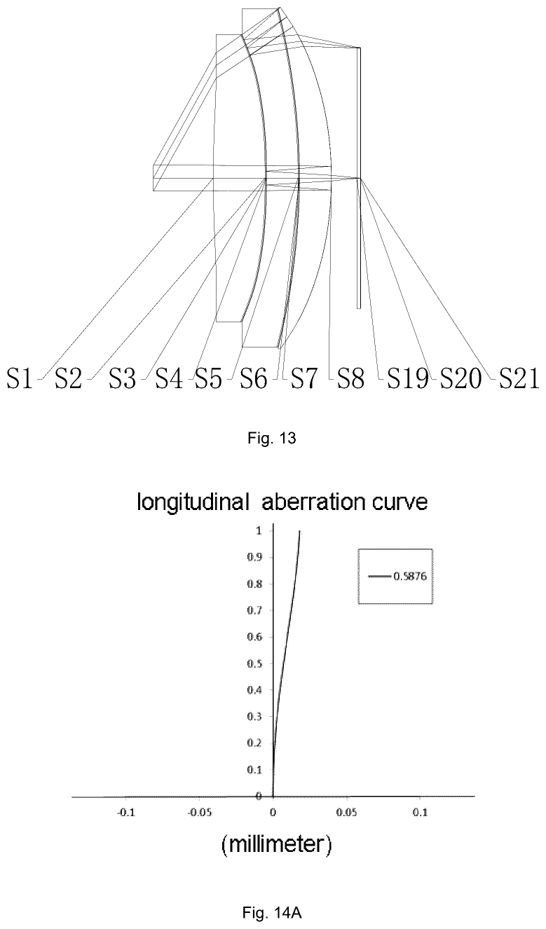

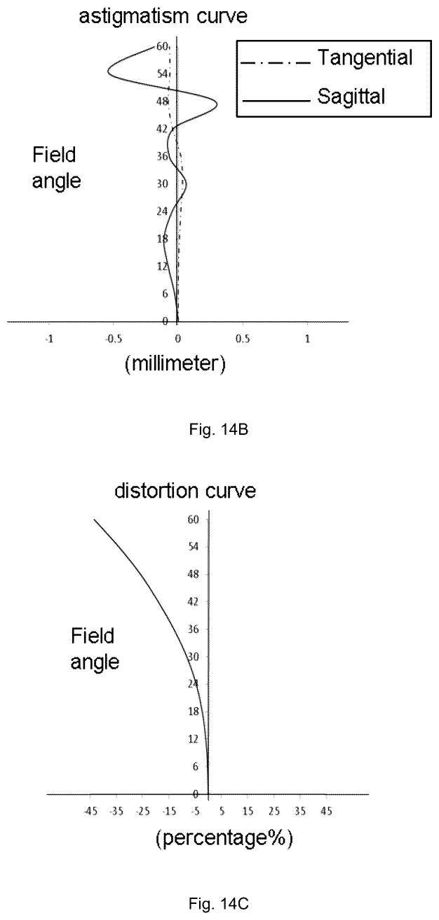

As shown in FIGS. 13 to 14C, the visual optical lens assembly 10 of Example VI is described. In particular, as shown in FIG. 13, in the visual optical lens assembly 10 of Example VI, the protection element 18 is glued to the light source surface 200 of the screen 20, so as to cause the image-side surface of the protection element 18 and the imaging surface IMG to be arranged at intervals. In this case, the glue coating layer 17 may be disposed between the protection element 18 and the screen 20. S19 indicates the object-side surface of the protection element 18; S20 indicates the image-side surface (i.e., an interface between the protection element 18 and the glue coating layer 17) of the protection element 18; and S21 indicates the imaging surface IMG (i.e., an interface between the screen 20 and the glue coating layer 17) of the visual optical lens assembly 10. Based on the above relational expression, Table 11 and Table 12 show design data of the visual optical lens assembly 10 of Example VI.

In particular, Table 11 shows basic optical parameters of the visual optical lens assembly 10 of Example VI; and Table 12 shows an Aspheric coefficient table of lens assemblies in the visual optical lens assembly 10 of Example VI.

TABLE 11
Basic optical parameters of visual optical lens assembly of Example VI

| | Surface | Surface | | Curvature | | | | | | Refraction | | Effective |
|---|---|---|---|---|---|---|---|---|---|---|---|---|
| | number | type | | radius | | Thickness | | Material | | mode | | radius |
| STO | | Spherical | | Infinite | | 12 | | | | | | 2 |
| | | surface | | | | | | | | | | |
| REFL1 | S1 | Aspheric | R1 | 166.9242 | CT1 | 10.4000 | N1V1 | 1.59 | 61.65 | Refraction | DT11 | 23.6859 |
| | | surface | | | | | | | | | | |
| glue | S2 | Aspheric | R2 | −173.0045 | glue | 0.2000 | | | | Refraction | DT12 | 27.5983 |
| | | surface | | | | | | | | | | |
| RP | S3 | Aspheric | | −173.0045 | CTRP | 0.0880 | NRP | 1.50 | 56.99 | Refraction | | 27.7030 |
| | | surface | | | | | VRP | | | | | |
| REFL2 | S4 | Aspheric | R3 | −173.0045 | CT2 | 6.3246 | N2V2 | 1.54 | 65.00 | Refraction | DT21 | 27.7499 |
| | | surface | | | | | | | | | | |
| glue | S5 | Spherical | R4 | −127.9596 | glue | 0.2000 | | | | Refraction | DT22 | 32.5612 |
| | | surface | | | | | | | | | | |
| QWP | S6 | Spherical | | −127.9596 | CTQWP | 0.0880 | NQWP | 1.50 | 56.99 | Refraction | | 32.6774 |
| | | surface | | | | | VQWP | | | | | |
| REFL3 | S7 | Spherical | R5 | −127.9596 | CT3 | 6.4000 | N3V3 | 1.58 | 60.16 | Refraction | DT31 | 32.7294 |
| | | surface | | | | | | | | | | |
| BS | S8 | Aspheric | R6 | −68.5788 | CT3 | −6.4000 | | | | Reflection | DT32 | 33.0035 |
| | | surface | | | | | | | | | | |
| QWP | S9 | Spherical | | −127.9596 | CTQWP | −0.0880 | | | | Refraction | | 32.6770 |
| | | surface | | | | | | | | | | |
| glue | S10 | Spherical | | −127.9596 | glue | −0.2000 | | | | Refraction | | 32.6146 |
| | | surface | | | | | | | | | | |
| REFL2 | S11 | Spherical | R4 | −127.9596 | CT2 | −6.3246 | N2V2 | 1.54 | 65.00 | Refraction | DT21 | 32.4756 |
| | | surface | | | | | | | | | | |
| | S12 | Aspheric | R3 | −173.0045 | CTRP | −0.0880 | | | | Refraction | DT22 | 26.8259 |
| | | surface | | | | | | | | | | |
| RP | S13 | Aspheric | | −173.0045 | CTRP | 0.088 | | | | Reflection | | 26.7700 |
| | | surface | | | | | | | | | | |
| REFL2 | S14 | Aspheric | R3 | −173.0045 | CT2 | 6.32459336 | N2V2 | 1.54 | 65.00 | Refraction | DT21 | 26.7766 |
| | | surface | | | | | | | | | | |
| glue | S15 | Spherical | R4 | −127.9596 | glue | 0.2 | | | | Refraction | DT22 | 27.4472 |
| | | surface | | | | | | | | | | |
| QWP | S16 | Spherical | | −127.9596 | CTQWP | 0.088 | | | | Refraction | | 27.4640 |
| | | surface | | | | | | | | | | |
| REFL3 | S17 | Spherical | R5 | −127.9596 | CT3 | 6.4 | N3V3 | 1.58 | 60.16 | Refraction | DT31 | 27.4711 |
| | | surface | | | | | | | | | | |
| BS | S18 | Aspheric | R6 | −68.5788 | | 5.12852068 | | | | Refraction | DT32 | 27.7081 |
| | | surface | | | | | | | | | | |
| FI | S19 | Spherical | | | | 0.7 | | 1.52 | 64.17 | Refraction | | 25.2828 |
| | | surface | | | | | | | | | | |
| | S20 | Spherical | | | | 0.05347153 | | | | Refraction | | 25.1895 |
| | | surface | | | | | | | | | | |
| IMG | S21 | Spherical | | | | 0 | | | | | | 25.1785 |
| | | surface | | | | | | | | | | |

It is to be noted that, in the above table, STO indicates the diaphragm; REFL1 indicates the first lens 11; glue indicates the glue coating layer 17; RP indicates the reflective polarizing element 12; REFL2 indicates the second lens 13; QWP indicates the quarter-wave plate 14; REFL3 indicates the third lens 15; BS indicates the partially-reflective element 16; and FI indicates the protection element 18. Furthermore, in the visual optical lens assembly 10 of Example VI, TTL=29.58 mm; ImgH=25.14 mm; HFOV=60°; BFL=5.88 mm; f1=449.85 mm; f2=−6809.48 mm; f3=−34.68 mm; f=25.66 mm.

TABLE 12
Aspheric coefficient table of lens assemblies in visual optical lens assembly of Example VI

| Surface | | | | | | | |
|---|---|---|---|---|---|---|---|
| number | A2 | A4 | A6 | A8 | A10 | A12 | A14 |
| S1 | −1.762E−05 | 1.788E−07 | −8.9114E−10 | 2.2875E−12 | −3.1969E−15 | 2.3231E−18 | −6.9018E−22 |
| S2 | −1.07E−05 | 4.8675E−09 | 1.5137E−10 | −5.9387E−13 | 9.4583E−16 | −6.9235E−19 | 1.9396E−22 |
| S3 | −1.07E−05 | 4.8675E−09 | 1.5137E−10 | −5.9387E−13 | 9.4583E−16 | −6.9235E−19 | 1.9396E−22 |
| S4 | −1.07E−05 | 4.8675E−09 | 1.5137E−10 | −5.9387E−13 | 9.4583E−16 | −6.9235E−19 | 1.9396E−22 |
| S8 | −4.091E−06 | 5.8877E−09 | 3.3147E−12 | −2.2781E−14 | 2.4465E−17 | −9.7717E−21 | 1.1369E−24 |
| S12 | −1.07E−05 | 4.8675E−09 | 1.5137E−10 | −5.9387E−13 | 9.4583E−16 | −6.9235E−19 | 1.9396E−22 |
| S13 | −1.07E−05 | 4.8675E−09 | 1.5137E−10 | −5.9387E−13 | 9.4583E−16 | −6.9235E−19 | 1.9396E−22 |
| S14 | −1.07E−05 | 4.8675E−09 | 1.5137E−10 | −5.9387E−13 | 9.4583E−16 | −6.9235E−19 | 1.9396E−22 |
| S18 | −4.091E−06 | 5.8877E−09 | 3.3147E−12 | −2.2781E−14 | 2.4465E−17 | −9.7717E−21 | 1.1369E−24 |

The following may be obtained through a simulation test, a longitudinal aberration curve of the visual optical lens assembly 10 of Example VI is shown in FIG. 14A; an astigmatism curve of the visual optical lens assembly 10 of Example VI is shown in FIG. 14B; and a distortion curve of the visual optical lens assembly 10 of Example VI is shown in FIG. 14C. According to FIG. 14A to FIG. 14C, it may be learned that, the visual optical lens assembly of Example VI can achieve desirable imaging quality.

### Example VII

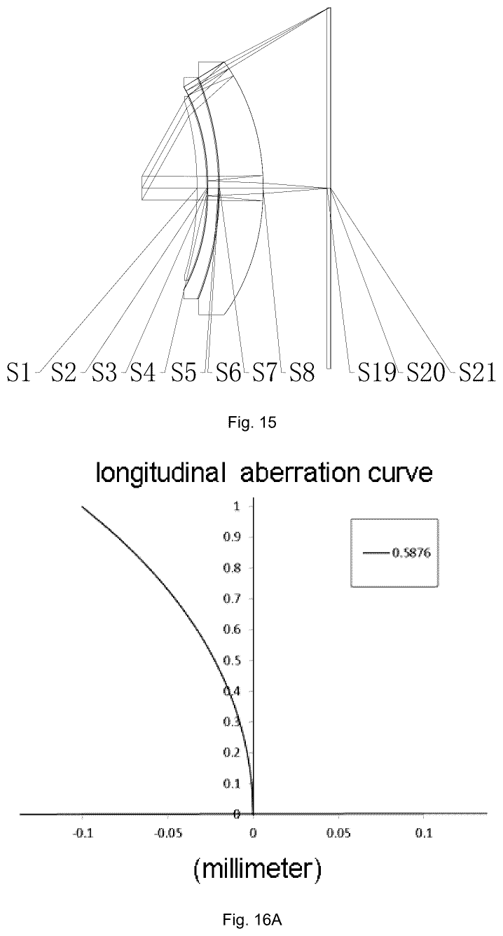

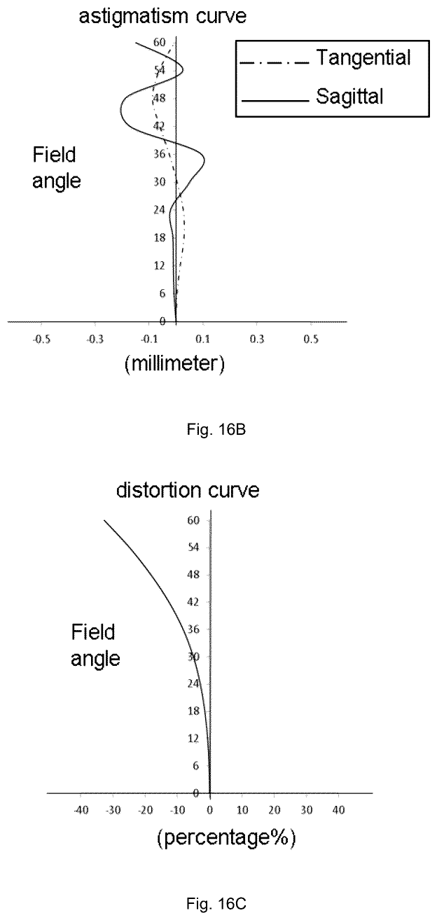

As shown in FIGS. 15 to 16C, the visual optical lens assembly 10 of Example VII is described. In particular, as shown in FIG. 15, in the visual optical lens assembly 10 of Example VII, the protection element 18 is glued to the light source surface 200 of the screen 20, so as to cause the image-side surface of the protection element 18 and the imaging surface IMG to be arranged at intervals. In this case, the glue coating layer 17 may be disposed between the protection element 18 and the screen 20. S19 indicates the object-side surface of the protection element 18; S20 indicates the image-side surface (i.e., an interface between the protection element 18 and the glue coating layer 17) of the protection element 18; and S21 indicates the imaging surface IMG (i.e., an interface between the screen 20 and the glue coating layer 17) of the visual optical lens assembly 10. Based on the above relational expression, Table 13 and Table 14 show design data of the visual optical lens assembly 10 of Example VII.

In particular, Table 13 shows basic optical parameters of the visual optical lens assembly 10 of Example VII; and Table 14 shows an Aspheric coefficient table of lens assemblies in the visual optical lens assembly 10 of Example VII.

TABLE 13
Basic optical parameters of visual optical lens assembly of Example VII

| | Surface | Surface | | Curvature | | | | | | Refraction | | Effective |
|---|---|---|---|---|---|---|---|---|---|---|---|---|
| | number | type | | radius | | Thickness | | Material | | mode | | radius |
| STO | | Spherical | | Infinite | | 12 | | | | | | 2 |
| | | surface | | | | | | | | | | |
| REFL1 | S1 | Aspheric | R1 | −69.8911 | CT1 | 2.0803 | N1V1 | 1.48 | 67.79 | Refraction | DT11 | 18.4539 |
| | | surface | | | | | | | | | | |
| glue | S2 | Aspheric | R2 | −60.0000 | glue | 0.2000 | | | | Refraction | DT12 | 19.2486 |
| | | surface | | | | | | | | | | |
| RP | S3 | Aspheric | | −60.0000 | CTRP | 0.0880 | NRP | 1.50 | 56.99 | Refraction | | 19.3828 |
| | | surface | | | | | VRP | | | | | |
| REFL2 | S4 | Aspheric | R3 | −60.0000 | CT2 | 2.2407 | N2V2 | 1.69 | 49.66 | Refraction | DT21 | 19.4414 |
| | | surface | | | | | | | | | | |
| glue | S5 | Spherical | R4 | −61.5529 | glue | 0.2000 | | | | Refraction | DT22 | 21.7095 |
| | | surface | | | | | | | | | | |
| QWP | S6 | Spherical | | −61.5529 | CTQWP | 0.0880 | NQWP | 1.50 | 56.99 | Refraction | | 21.8465 |
| | | surface | | | | | VQWP | | | | | |
| REFL3 | S7 | Spherical | R5 | −61.5529 | CT3 | 9.4714 | N3V3 | 1.63 | 54.53 | Refraction | DT31 | 21.9115 |
| | | surface | | | | | | | | | | |
| BS | S8 | Aspheric | R6 | −51.2260 | CT3 | −9.4714 | | | | Reflection | DT32 | 26.6692 |
| | | surface | | | | | | | | | | |
| QWP | S9 | Spherical | | −61.5529 | CTQWP | −0.0880 | | | | Refraction | | 23.2948 |
| | | surface | | | | | | | | | | |
| glue | S10 | Spherical | | −61.5529 | glue | −0.2000 | | | | Refraction | | 23.2508 |
| | | surface | | | | | | | | | | |
| REFL2 | S11 | Spherical | R4 | −61.5529 | CT2 | −2.2407 | N2V2 | 1.69 | 49.66 | Refraction | DT21 | 23.1541 |
| | | surface | | | | | | | | | | |
| | S12 | Aspheric | R3 | −60.0000 | CTRP | −0.0880 | | | | Refraction | DT22 | 21.3807 |
| | | surface | | | | | | | | | | |
| RP | S13 | Aspheric | | −60.0000 | CTRP | 0.088 | | | | Reflection | | 21.3417 |
| | | surface | | | | | | | | | | |
| REFL2 | S14 | Aspheric | R3 | −60.0000 | CT2 | 2.24068816 | N2V2 | 1.69 | 49.66 | Refraction | DT21 | 21.3801 |
| | | surface | | | | | | | | | | |
| glue | S15 | Spherical | R4 | −61.5529 | glue | 0.2 | | | | Refraction | DT22 | 23.1260 |
| | | surface | | | | | | | | | | |
| QWP | S16 | Spherical | | −61.5529 | CTQWP | 0.088 | | | | Refraction | | 23.2211 |
| | | surface | | | | | | | | | | |
| REFL3 | S17 | Spherical | R5 | −61.5529 | CT3 | 9.47136744 | N3V3 | 1.63 | 54.53 | Refraction | DT31 | 23.2644 |
| | | surface | | | | | | | | | | |
| BS | S18 | Aspheric | R6 | −51.2260 | | 13.8759914 | | | | Refraction | DT32 | 26.5974 |
| | | surface | | | | | | | | | | |
| FI | S19 | Spherical | | | | 0.7 | | 1.52 | 64.17 | Refraction | | 37.8354 |
| | | surface | | | | | | | | | | |
| | S20 | Spherical | | | | 0.14008747 | | | | Refraction | | 38.0526 |
| | | surface | | | | | | | | | | |
| IMG | S21 | Spherical | | | | 0 | | | | | | 38.1231 |
| | | surface | | | | | | | | | | |

It is to be noted that, in the above table, STO indicates the diaphragm; REFL1 indicates the first lens 11; glue indicates the glue coating layer 17; RP indicates the reflective polarizing element 12; REFL2 indicates the second lens 13; QWP indicates the quarter-wave plate 14; REFL3 indicates the third lens 15; BS indicates the partially-reflective element 16; and FI indicates the protection element 18. Furthermore, in the visual optical lens assembly 10 of Example VII, TTL=29.08 mm; ImgH=38.11 mm; HFOV=600; BFL=14.72 mm; f1=−215.50 mm; f2=−533.67 mm; f3=−26.16 mm; f=14.72 mm.

TABLE 14
Aspheric coefficient table of lens assemblies in visual optical lens assembly of Example VII

| Surface | | | | | | | |
|---|---|---|---|---|---|---|---|
| number | A2 | A4 | A6 | A8 | A10 | A12 | A14 |
| S1 | −1.762E−05 | 1.788E−07 | −8.9114E−10 | 2.2875E−12 | −3.1969E−15 | 2.3231E−18 | −6.9018E−22 |
| S2 | −1.07E−05 | 4.8675E−09 | 1.5137E−10 | −5.9387E−13 | 9.4583E−16 | −6.9235E−19 | 1.9396E−22 |
| S3 | −1.07E−05 | 4.8675E−09 | 1.5137E−10 | −5.9387E−13 | 9.4583E−16 | −6.9235E−19 | 1.9396E−22 |
| S4 | −1.07E−05 | 4.8675E−09 | 1.5137E−10 | −5.9387E−13 | 9.4583E−16 | −6.9235E−19 | 1.9396E−22 |
| S8 | −4.091E−06 | 5.8877E−09 | 3.3147E−12 | −2.2781E−14 | 2.4465E−17 | −9.7717E−21 | 1.1369E−24 |
| S12 | −1.07E−05 | 4.8675E−09 | 1.5137E−10 | −5.9387E−13 | 9.4583E−16 | −6.9235E−19 | 1.9396E−22 |
| S13 | −1.07E−05 | 4.8675E−09 | 1.5137E−10 | −5.9387E−13 | 9.4583E−16 | −6.9235E−19 | 1.9396E−22 |
| S14 | −1.07E−05 | 4.8675E−09 | 1.5137E−10 | −5.9387E−13 | 9.4583E−16 | −6.9235E−19 | 1.9396E−22 |
| S18 | −4.091E−06 | 5.8877E−09 | 3.3147E−12 | −2.2781E−14 | 2.4465E−17 | −9.7717E−21 | 1.1369E−24 |

The following may be obtained through a simulation test, a longitudinal aberration curve of the visual optical lens assembly 10 of Example VII is shown in FIG. 16A; an astigmatism curve of the visual optical lens assembly 10 of Example VII is shown in FIG. 16B; and a distortion curve of the visual optical lens assembly 10 of Example VII is shown in FIG. 16C. According to FIG. 16A to FIG. 16C, it may be learned that, the visual optical lens assembly of Example VII can achieve desirable imaging quality.

### Example VIII

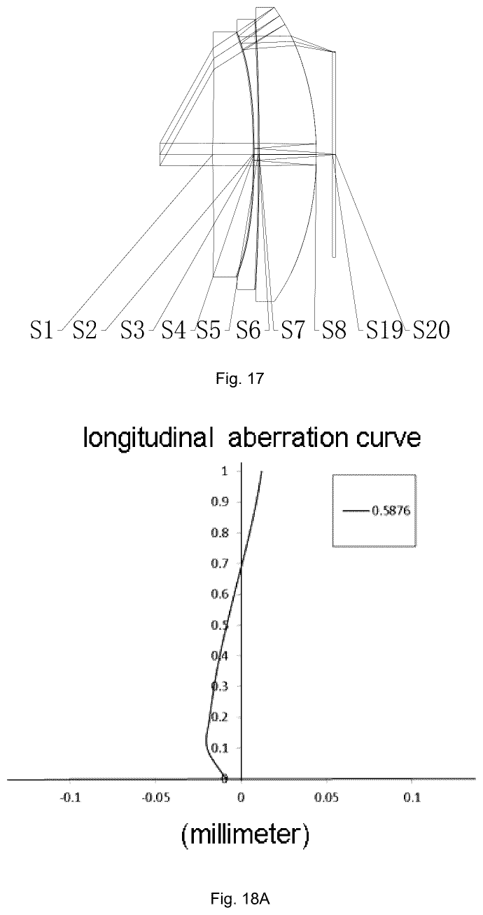

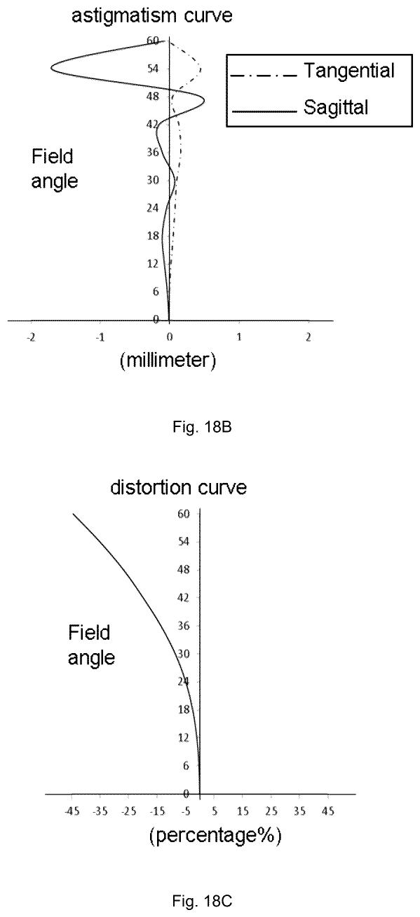

As shown in FIGS. 17 to 18C, the visual optical lens assembly 10 of Example VIII is described. In particular, as shown in FIG. 17, in the visual optical lens assembly 10 of Example VIII, the protection element 18 is directly attached to the light source surface 200 of the screen 20, so as to cause the image-side surface of the protection element 18 to coincide with the imaging surface IMG, that is, S20 indicates an interface between the protection element 18 and the screen 20. Based on the above relational expression, Table 15 and Table 16 show design data of the visual optical lens assembly 10 of Example VIII.

In particular, Table 15 shows basic optical parameters of the visual optical lens assembly 10 of Example VIII; and Table 16 shows an Aspheric coefficient table of lens assemblies in the visual optical lens assembly 10 of Example VIII.

TABLE 15
Basic optical parameters of visual optical lens assembly of Example VIII

| | Surface | Surface | | Curvature | | | | | | Refraction | | Effective |
|---|---|---|---|---|---|---|---|---|---|---|---|---|
| | number | type | | radius | | Thickness | | Material | | mode | | radius |
| STO | | Spherical | | Infinite | | 12 | | | | | | 2 |
| | | surface | | | | | | | | | | |
| REFL1 | S1 | Aspheric | R1 | 238.4579 | CT1 | 9.1513 | N1V1 | 1.69 | 49.67 | Refraction | DT11 | 23.0058 |
| | | surface | | | | | | | | | | |
| glue | S2 | Aspheric | R2 | −240.0000 | glue | 0.2000 | | | | Refraction | DT12 | 26.8370 |
| | | surface | | | | | | | | | | |
| RP | S3 | Aspheric | | −240.0000 | CTRP | 0.0880 | NRP | 1.50 | 56.99 | Refraction | | 26.9414 |
| | | surface | | | | | VRP | | | | | |
| REFL2 | S4 | Aspheric | R3 | −240.0000 | CT2 | 0.8868 | N2V2 | 1.63 | 46.54 | Refraction | DT21 | 26.9896 |
| | | surface | | | | | | | | | | |
| glue | S5 | Spherical | R4 | −548.7117 | glue | 0.2000 | | | | Refraction | DT22 | 29.5949 |
| | | surface | | | | | | | | | | |
| QWP | S6 | Spherical | | −548.7117 | CTQWP | 0.0880 | NQW | 1.50 | 56.99 | Refraction | | 29.7219 |
| | | surface | | | | | PVQWP | | | | | |
| REFL3 | S7 | Spherical | R5 | −548.7117 | CT3 | 12.9297 | N3V3 | 1.67 | 48.00 | Refraction | DT31 | 29.7842 |
| | | surface | | | | | | | | | | |
| BS | S8 | Aspheric | R6 | −70.4214 | CT3 | −12.9297 | | | | Reflection | DT32 | 32.4737 |
| | | surface | | | | | | | | | | |
| QWP | S9 | Spherical | | −548.7117 | CTQWP | −0.0880 | | | | Refraction | | 29.2423 |
| | | surface | | | | | | | | | | |
| glue | S10 | Spherical | | −548.7117 | glue | −0.2000 | | | | Refraction | | 29.1659 |
| | | surface | | | | | | | | | | |
| REFL2 | S11 | Spherical | R4 | −548.7117 | CT2 | −0.8868 | N2V2 | 1.63 | 46.54 | Refraction | DT21 | 29.0126 |
| | | surface | | | | | | | | | | |
| | S12 | Aspheric | R3 | −240.0000 | CTRP | −0.0880 | | | | Refraction | DT22 | 26.0853 |
| | | surface | | | | | | | | | | |
| RP | S13 | Aspheric | | −240.0000 | CTRP | 0.088 | | | | Reflection | | 26.0279 |
| | | surface | | | | | | | | | | |
| REFL2 | S14 | Aspheric | R3 | −240.0000 | CT2 | 0.88681049 | N2V2 | 1.63 | 46.54 | Refraction | DT21 | 26.0261 |
| | | surface | | | | | | | | | | |
| glue | S15 | Spherical | R4 | −548.7117 | glue | 0.2 | | | | Refraction | DT22 | 26.0652 |
| | | surface | | | | | | | | | | |
| QWP | S16 | Spherical | | −548.7117 | CTQWP | 0.088 | | | | Refraction | | 26.0673 |
| | | surface | | | | | | | | | | |
| REFL3 | S17 | Spherical | R5 | −548.7117 | CT3 | 12.9297384 | N3V3 | 1.67 | 48.00 | Refraction | DT31 | 26.0679 |
| | | surface | | | | | | | | | | |
| BS | S18 | Aspheric | R6 | −70.4214 | | 3.681878 | | | | Refraction | DT32 | 26.1549 |
| | | surface | | | | | | | | | | |
| FI | S19 | Spherical | | | | 0.7 | | 1.52 | 64.17 | Refraction | | 22.7127 |
| | | surface | | | | | | | | | | |
| IMG | S20 | Spherical | | | | 0 | | | | Refraction | | 22.5511 |
| | | surface | | | | | | | | | | |

It is to be noted that, in the above table, STO indicates the diaphragm; REFL1 indicates the first lens 11; glue indicates the glue coating layer 17; RP indicates the reflective polarizing element 12; REFL2 indicates the second lens 13; QWP indicates the quarter-wave plate 14; REFL3 indicates the third lens 15; BS indicates the partially-reflective element 16; and FI indicates the protection element 18. Furthermore, in the visual optical lens assembly 10 of Example VIII, TTL=27.93 mm; ImgH=22.53 mm; HFOV=60°; BFL=4.38 mm; f1=584.05 mm; f2=−2948.90 mm; f3=−35.35 mm; f=35.46 mm.

TABLE 16
Aspheric coefficient table of lens assemblies in visual optical lens assembly of Example VIII

| Surface | | | | | | | |
|---|---|---|---|---|---|---|---|
| number | A2 | A4 | A6 | A8 | A10 | A12 | A14 |
| S1 | −1.762E−05 | 1.788E−07 | −8.9114E−10 | 2.2875E−12 | −3.1969E−15 | 2.3231E−18 | −6.9018E−22 |
| S2 | −1.07E−05 | 4.8675E−09 | 1.5137E−10 | −5.9387E−13 | 9.4583E−16 | −6.9235E−19 | 1.9396E−22 |
| S3 | −1.07E−05 | 4.8675E−09 | 1.5137E−10 | −5.9387E−13 | 9.4583E−16 | −6.9235E−19 | 1.9396E−22 |
| S4 | −1.07E−05 | 4.8675E−09 | 1.5137E−10 | −5.9387E−13 | 9.4583E−16 | −6.9235E−19 | 1.9396E−22 |
| S8 | −4.091E−06 | 5.8877E−09 | 3.3147E−12 | −2.2781E−14 | 2.4465E−17 | −9.7717E−21 | 1.1369E−24 |
| S12 | −1.07E−05 | 4.8675E−09 | 1.5137E−10 | −5.9387E−13 | 9.4583E−16 | −6.9235E−19 | 1.9396E−22 |
| S13 | −1.07E−05 | 4.8675E−09 | 1.5137E−10 | −5.9387E−13 | 9.4583E−16 | −6.9235E−19 | 1.9396E−22 |
| S14 | −1.07E−05 | 4.8675E−09 | 1.5137E−10 | −5.9387E−13 | 9.4583E−16 | −6.9235E−19 | 1.9396E−22 |
| S18 | −4.091E−06 | 5.8877E−09 | 3.3147E−12 | −2.2781E−14 | 2.4465E−17 | −9.7717E−21 | 1.1369E−24 |

The following may be obtained through a simulation test, a longitudinal aberration curve of the visual optical lens assembly 10 of Example VIII is shown in FIG. 18A; an astigmatism curve of the visual optical lens assembly 10 of Example VIII is shown in FIG. 18B; and a distortion curve of the visual optical lens assembly 10 of Example VIII is shown in FIG. 18C. According to FIG. 18A to FIG. 18C, it may be learned that, the visual optical lens assembly of Example VIII can achieve desirable imaging quality.

To sum up, the visual optical lens assemblies in Example I to Example VIII meet relationships in Table 17, and details are shown in Table 17.

TABLE 17
Relational expression table met by visual optical lens assembly

| Conditional expression/example | 1 | 2 | 3 | 4 | 5 | 6 | 7 | 8 |
|---|---|---|---|---|---|---|---|---|
| ΣCT/TD | 0.97 | 0.97 | 0.97 | 0.97 | 0.97 | 0.98 | 0.96 | 0.98 |
| TTL/(ImgH*tan(Semi-FOV)) | 1.67 | 1.67 | 1.56 | 1.51 | 1.72 | 2.04 | 1.32 | 2.15 |
| BFL/f | 0.21 | 0.32 | 0.39 | 0.17 | 0.25 | 0.23 | 0.39 | 0.12 |
| EPD/ImgH | 0.25 | 0.16 | 0.15 | 0.17 | 0.17 | 0.20 | 0.15 | 0.34 |
| (f1*N1)/(f2*N2) | 0.65 | 0.82 | 0.22 | −1.05 | −0.05 | −0.07 | 0.35 | −0.20 |
| ΣET/ΣCT | 0.57 | 0.58 | 0.59 | 0.62 | 0.54 | 0.54 | 0.60 | 0.58 |
| f3/f | −0.72 | −1.09 | −0.92 | −1.28 | −1.18 | −1.35 | −0.69 | −1.00 |
| (CT2*N2 + CT3*N3)/TTL | 0.66 | 0.66 | 0.64 | 1.00 | 0.69 | 0.67 | 0.66 | 0.82 |
| N2/NRP | 1.03 | 1.03 | 1.06 | 1.06 | 1.01 | 1.03 | 1.13 | 1.09 |
| N3/NQWP | 1.03 | 1.03 | 1.06 | 1.05 | 1.01 | 1.05 | 1.09 | 1.11 |

Various technical features of the above embodiments may be combined arbitrarily. For brevity of description, description is not made to all possible combinations of the various technical features of the above embodiments are described. However, all the combinations of these technical features should be considered to fall within the scope of disclosure contained in the specification as long as there is no contradiction between the combinations of those technical features.

The above embodiments merely illustrate several implementations of the disclosure, which are specifically described in detail, but are not to be construed as limiting the scope of the present patent for the disclosure. It should be pointed out that those of ordinary skill in the art can also make some modifications and improvements without departing from the concept of the disclosure, and these modifications and improvements all fall within the scope of protection of the disclosure.

What is claimed is:

1. A visual optical lens assembly, sequentially comprising, along an optical axis from an object side to an image side: a first lens having a refractive power, a reflective polarizing element, a second lens having a negative refractive power, a quarter-wave plate, a third lens having a negative refractive power, and a partially-reflective element, wherein an image-side surface of the first lens is a convex surface; an object-side surface of the second lens is a concave surface, and an image-side surface of the second lens is a convex surface; an object-side surface of the third lens is a concave surface, and an image-side surface of the third lens is a convex surface; the first lens, the second lens, and the third lens are sequentially glued, and the visual optical lens assembly meets a relational expression:
$$1.3 < TTL / ( ImgH \times tan ( Semi - F O V ) ) < 2.2 ; and$$
$$0.9 < \sum CT / TD < 1 ,$$
wherein
the TTL is an on-axis distance between an object-side surface of the first lens and an imaging surface of the visual optical lens assembly; ImgH is half a diagonal length of an effective pixel region on the imaging surface of the visual optical lens assembly; the Semi-FOV is half a maximum Field Of View (FOV) of the visual optical lens assembly; the ΣCT is a sum of center thicknesses of the first lens, the second lens, and the third lens on the optical axis; and the TD is an on-axis distance between the object-side surface of the first lens and the image-side surface of the third lens.

2. The visual optical lens assembly according to claim 1, wherein the visual optical lens assembly further meets a relational expression:
$$0.1 < BFL / f < 0.4 ,$$
the BFL is an on-axis distance between the image-side surface of the third lens and the imaging surface of the visual optical lens assembly; and the f is an effective focal length of the visual optical lens assembly.

3. The visual optical lens assembly according to claim 1, wherein the visual optical lens assembly further meets a relational expression:
$$0.1 < EPD / ImgH < 0.4 ,$$
wherein
the EPD is an Entrance Pupil Diameter (EPD) of the visual optical lens assembly; and the ImgH is half the diagonal length of the effective pixel region on the imaging surface of the visual optical lens assembly.

4. The visual optical lens assembly according to claim 1, wherein the first lens and the second lens meet a relational expression:
$$- 1.1 < ( f 1 * N 1 ) / ( f 2 * N 2 ) < 0.9 ,$$
the f1 is an effective focal length of the first lens; the f2 is an effective focal length of the second lens; the N1 is a refractive index of the first lens; and the N2 is a refractive index of the second lens.

5. The visual optical lens assembly according to claim 1, wherein the first lens, the second lens, and the third lens meet a relational expression:
$$0.5 < \sum ET / \sum CT < 0.7 ,$$
the ΣET is a sum of edge thicknesses of the first lens, the second lens, and the third lens; and the ΣCT is the sum of center thicknesses of the first lens, the second lens, and the third lens on the optical axis.

6. The visual optical lens assembly according to claim 1, wherein the third lens meets a relational expression:
$$- 1.4 < f 3 / f < - 0.6 ,$$
wherein
the f3 is an effective focal length of the third lens; and the f is an effective focal length of the visual optical lens assembly.

7. The visual optical lens assembly according to claim 1, wherein the second lens and the third lens meet a relational expression:
$$0.6 < ( CT 2 * N 2 + CT 3 * N 3 ) / TTL < 1.1 ,$$
the CT2 is the center thickness of the second lens; the N2 is a refractive index of the second lens; the CT3 is the center thickness of the third lens; the N3 is a refractive index of the third lens; and the TTL is the on-axis distance between the object-side surface of the first lens and the imaging surface of the visual optical lens assembly.

8. The visual optical lens assembly according to claim 1, wherein a curvature radius of the image-side surface of the first lens is equal to a curvature radius of the object-side surface of the second lens; and a curvature radius of the image-side surface of the second lens is equal to a curvature radius of the object-side surface of the third lens.

9. The visual optical lens assembly according to claim 1, wherein the reflective polarizing element is a reflective polarizing film attached to the object-side surface of the second lens; and the quarter-wave plate is attached to the object-side surface of the third lens.

10. The visual optical lens assembly according to claim 1, wherein a center thickness of the reflective polarizing element is equal to a center thickness of the quarter-wave plate.

11. The visual optical lens assembly according to claim 1, wherein a refractive index of the reflective polarizing element is equal to a refractive index of the quarter-wave plate; and an abbe number of the reflective polarizing element is equal to an abbe number of the quarter-wave plate.

12. The visual optical lens assembly according to claim 1, wherein the second lens and the reflective polarizing element meet a relational expression:
$$1 < N 2 / NRP < 1.2 ,$$
wherein
the N2 is the refractive index of the second lens; and the NRP is a refractive index of the reflective polarizing element.

13. The visual optical lens assembly according to claim 1, wherein the third lens and the quarter-wave plate meet a relational expression:
$$1 < N 3 / NQWP < 1.2 ,$$
wherein
the N3 is the refractive index of the third lens, and the NQWP is a refractive index of the quarter-wave plate.

14. The visual optical lens assembly according to claim 1, wherein the partially-reflective element is a semi-reflective and semi-permeable film glued with the image-side surface of the third lens.

15. The visual optical lens assembly according to claim 1, wherein the visual optical lens assembly further comprises glue coating layers located among the first lens, the second lens, and the third lens.

16. A Virtual Reality eyepiece system, comprising:
the visual optical lens assembly according to claim 1; and
a screen, wherein the screen is disposed on an image side of the visual optical lens assembly, and a light source surface of the screen is located on an imaging surface of the visual optical lens assembly.

17. The Virtual Reality eyepiece system according to claim 16, wherein the visual optical lens assembly further meets a relational expression:
$$0.1 < BFL / f < 0.4 ,$$
the BFL is an on-axis distance between the image-side surface of the third lens and the imaging surface of the visual optical lens assembly; and the f is an effective focal length of the visual optical lens assembly.

18. The Virtual Reality eyepiece system according to claim 16, wherein the visual optical lens assembly further meets a relational expression:
$$0.1 < EPD / ImgH < 0.4 ,$$
wherein
the EPD is an Entrance Pupil Diameter (EPD) of the visual optical lens assembly; and the ImgH is half the diagonal length of the effective pixel region on the imaging surface of the visual optical lens assembly.

19. The Virtual Reality eyepiece system according to claim 16, wherein the first lens and the second lens meet a relational expression:
$$- 1.1 < ( f 1 * N 1 ) / ( f 2 * N 2 ) < 0.9 ,$$
the f1 is an effective focal length of the first lens; the f2 is an effective focal length of the second lens; the N1 is a refractive index of the first lens; and the N2 is a refractive index of the second lens.

20. The Virtual Reality eyepiece system according to claim 16, wherein the first lens, the second lens, and the third lens meet a relational expression:
$$0.5 < \sum ET / \sum CT < 0.7 ,$$
the ΣET is a sum of edge thicknesses of the first lens, the second lens, and the third lens; and the ΣCT is the sum of center thicknesses of the first lens, the second lens, and the third lens on the optical axis.
